(19) United States
(12) Patent Application Publication
(10) Pub. No.: US 2023/0072539 A1
(43) Pub. Date: Mar. 9, 2023

(54) Artificial Intelligence (AI) System for Learning Spatial Patterns in Sparse Distributed Representations (SDRs) and Associated Methods

(71) Applicant: Natural Intelligence Systems, Inc., Boise, ID (US)

(72) Inventors: Harold B Noyes, Boise, ID (US); David Roberts, Meridian, ID (US); Russell B. Lloyd, Boise, ID (US); William Tiffany, Eagle, ID (US); Jeffery Tanner, Meridian, ID (US); Terrence Leslie, Reva, VA (US); Daniel Skinner, Meridian, ID (US); Indranil Roy, Boise, ID (US)

(21) Appl. No.: 17/877,724

(22) Filed: Jul. 29, 2022

Related U.S. Application Data
(60) Provisional application No. 63/227,590, filed on Jul. 30, 2021.

(51) Int. Cl. G06N 3/063; G06K 9/62; G06F 9/38

(52) U.S. Cl. CPC G06N 3/063; G06K 9/628; G06F 9/3889

(57) ABSTRACT

Introduced here is an artificial intelligence system designed for machine learning. The system may be based on a neuromorphic computational model that learns spatial patterns in inputs using data structures called Sparse Distributed Representations (SDRs) to represent the inputs. Moreover, the system can generate signatures for these SDRs, and these signatures may be used to create definitions of classes or subclasses for classification purposes.

### CROSS-REFERENCE TO RELATED APPLICATIONS

This application claims priority to U.S. Provisional Application No. 63/227,590, titled “Explainable Machine Learning (ML) and Artificial Intelligence (AI) Methods and Systems Using Encoders, Neural Processing Units (NPUs), and Classifiers” and filed on Jul. 30, 2021, which is incorporated by reference herein in its entirety.

This application is related to U.S. application Ser. No. 17/531,576, titled “Neural Processing Units (NPUs) and Computational Systems Employing the Same” and filed on Nov. 19, 2021, which is also incorporated by reference herein in its entirety.

### TECHNICAL FIELD

Various embodiments concern processing units with hardware architectures suitable for artificial intelligence and machine learning processes, as well as computational systems capable of employing the same.

### BACKGROUND

Historically, artificial intelligence (AI) and machine learning (ML) processes have been implemented by computational systems (or simply “systems”) that execute sophisticated software using conventional processing units, such as central processing units (CPUs) and graphics processing units (GPUs). While the hardware architectures of these conventional processing units are able to execute the necessary computations, actual performance is slow relative to desired performance. Simply put, performance is impacted because too much data and too many computations are required.

This impact on performance can have significant ramifications. As an example, if performance suffers to such a degree that delay occurs, then AI and ML processes may not be implementable in certain situations. For instance, delays of less than one second may prevent implementation of AI and ML processes where timeliness is necessary, such as for automated driving systems where real-time AI and ML processing affects passenger safety. Another real-time system example is military targeting systems, where friend-or-foe decisions must be made and acted upon before loss of life occurs. Any scenario where real-time decisions can impact life, safety, or capital assets are applications where faster AI and ML processing is needed.

Entities have historically attempted to address this impact on performance by increasing the computational resources that are available to the system. There are several drawbacks to this approach, however. First, increasing the computational resources may be impractical or impossible. This is especially true if the AI and ML processes are intended to be implemented by systems that are included in computing devices such as mobile phones, tablet computers, and the like. Second, increasing the computational resources will lead to an increase in power consumption. The power available to a system can be limited (e.g., due to battery constraints), so limiting power consumption is an important aspect of developing new technologies.

### BRIEF DESCRIPTION OF THE DRAWINGS

The patent or application file contains at least one drawing executed in color. Copies of this patent or patent application publication with color drawing(s) will be provided by the Office upon request and payment of the necessary fees.

FIG. 1 includes a diagrammatic illustration of a software pipeline for machine learning.

FIG. 2 includes a diagrammatic illustration of the software pipeline of FIG. 1 while in the training mode.

FIG. 3 includes a diagrammatic illustration of the software pipeline of FIG. 1 while in the inferencing mode.

FIG. 4 includes examples of linearly encoded Sparse Distributed Representations (SDRs) for 14 possible bucket identifiers (i.e., ID₀-ID₁₃) using an SDR length of 16 bits (i.e., Bit₀-Bit₁₅) with 3 set bits.

FIG. 5 shows the overlap between any pair of linearly encoded SDRs can be represented as a heat map graph.

FIG. 6 illustrates how adaptively encoding bucket identifiers can be employed with 16-bit SDRs where 3 bits are set within a span of 5 bits.

FIG. 7 includes a heat map graph that shows the degree of overlap between 120 SDRs by adaptive encoding.

FIG. 8 illustrates how a hybrid approach to encoding can be employed.

FIG. 9 includes a heat map graph showing the degree of overlap between SDRs generated in accordance with the hybrid approach.

FIG. 10 includes an overview of the sorting process by which winning neurons can be identified by a Neural Processing Unit (NPU).

FIG. 11 includes an example of a data structure populated with information that can be used to identify the corresponding neuron.

FIG. 12 includes an example of a data structure with additional information, namely, an NPU index.

FIG. 13 includes an example of a multi-NPU system in which SDRs are requested of three winning neurons.

FIG. 14 includes the sorted output of the SDRs output by the NPUs.

FIG. 15 shows the SDRs corresponding to the actual winning neurons.

FIG. 16 includes the SDRs of training samples in three separate classes, namely, Class 0, Class 1, and Class 2.

FIG. 17 shows histograms that have been produced for Class 0, Class 1, and Class 2 for the training data described with respect to FIG. 16.

FIG. 18 shows how the system may handle the first training SDR of Class 0.

FIG. 19 illustrates how the second training SDR corresponding to Class 0 can be handled.

FIG. 20 illustrates how to handle a third training SDR corresponding to Class 0.

FIG. 21 illustrates how to handle a fourth training SDR corresponding to Class 0.

FIG. 22 shows the effects of processing a fifth training SDR corresponding to Class 0.

FIG. 23 shows the effects of processing a sixth training SDR corresponding to Class 0.

FIG. 24 shows all of the subclasses that are formed after processing all of the training SDRs for Class 0, Class 1, and Class 2 as shown in FIG. 16.

FIG. 25 illustrates the calculated overlap of a testing SDR with the signature SDRs corresponding to all subclasses of all classes.

FIG. 26 includes a flow diagram of a process for classifying high-dimensional signatures in a supervised manner.

FIG. 27 illustrates how the synapses for each of the neurons included in an NPU can be identified and mapped onto a histogram.

FIG. 28 shows how the histogram can be filtered by setting a synapse threshold.

FIG. 29 includes an example of a graph illustrating the mapping of synaptic connections to encoder buckets.

FIG. 30 shows how the synapse-to-encoder buckets can be filtered by setting a bucket threshold.

FIG. 31 shows ranges of raw data for a four-feature dataset in bar-chart format.

FIG. 32 shows how data may not sufficiently correspond with the visualization component generated for a given signature, in which case the data may be more similar to another signature.

FIG. 33 illustrates how a heat map graph could be used to show synaptic connections.

Features of the technology described herein will become more apparent to those skilled in the art from a study of the Detailed Description in conjunction with the drawings. Various embodiments are depicted in the drawings for the purpose of illustration. However, those skilled in the art will recognize that alternative embodiments may be employed without departing from the principles of the present disclosure. Accordingly, although specific embodiments are shown in the drawings, the technology is amenable to various modifications.

### DETAILED DESCRIPTION

Introduced here is an artificial intelligence (AI) system designed for machine learning (ML). As further discussed below, the system may be based on a neuromorphic computational model that learns spatial patterns in inputs using data structures called Sparse Distributed Representations (SDRs). At a high level, an SDR may be representative of a sparse, high-dimensional bit vector whose unique mathematical properties can be leveraged by the system. Note that the term “bit vector” may be used synonymously with the terms “bit array,” “bit map,” “bit set,” and “bit string.”

One of the more interesting challenges in AI is the problem of knowledge representation. Representing information and relationships in a form that computing devices can handle has proven to be difficult with traditional approaches focused on computer science. The underlying problem is that knowledge generally cannot be defined as, or divided into, discrete pieces of information with well-defined relationships. To address this problem, SDRs can be used in an effort to emulate the biological intelligence of the human brain. Generally, an SDR includes hundreds or thousands of bits, and at any given point in time, a small percentage of the bits are ones while the remaining bits are zeros. At a high level, the bits are meant to correspond to neurons in a human brain, where a one represents a relatively active neuron and a zero represents a relatively inactive neuron. An important feature of SDRs is that each bit has meaning. Therefore, the bits that are “active” in a given representation will encode a corresponding set of semantic attributes of what is meant to be represented. Rather than labeling each bit, the meaning of each bit can be learned.

As further discussed below, the neuromorphic computational model can be executed entirely in software, for example, on conventional processing units, such as central processing units (CPUs) and graphics processing units (GPUs), or specialized processing units, such as neural processing units (NPUs). Accordingly, the approaches introduced here could be implemented through the execution—by a conventional processing unit and/or a specialized processing unit—of instructions in a non-transitory medium. Note that while embodiments may be described in the context of software, features of those embodiments may be similarly applicable to firmware and hardware.

### Overview of Software Pipeline

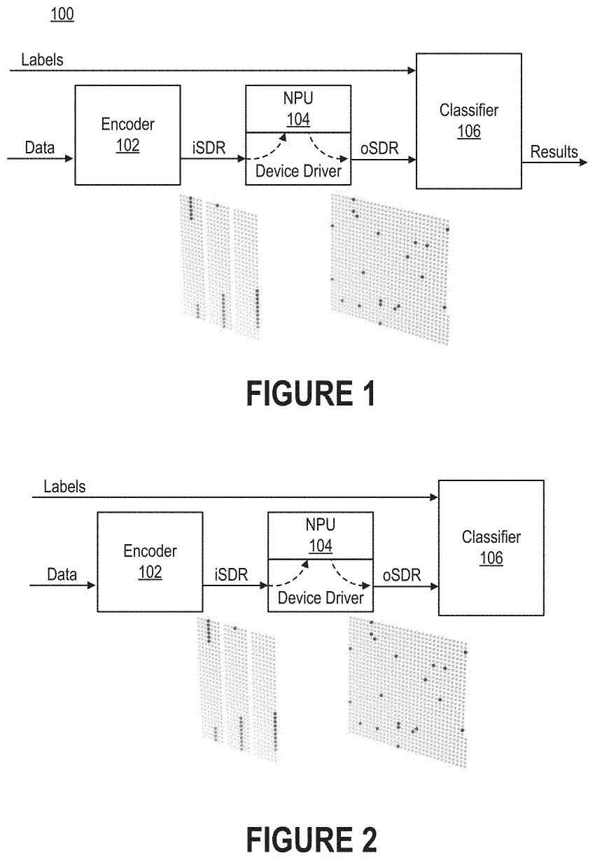

FIG. 1 includes a diagrammatic illustration of a software pipeline 100 for ML. The term “software pipeline” may be used to refer to a series of processing elements that are “chained” together, arranged so that the output of each processing element is the input of the next processing element. As shown in FIG. 1, the software pipeline 100 can include three processing elements, namely, an encoder 102, an NPU 104, and a classifier 106. The processing elements—each of which is representative of a different “stage” in the software pipeline—are described in further detail below.

Note that FIG. 1 combines two different modes of operation: (i) a training mode and (ii) an inferencing mode.

While in the training mode, the system “learns” patterns in data that is provided as input. This data is commonly referred to as “training data.” The training mode is considered to be “supervised” when the training data includes, or is accompanied by, labels for particular outputs. Conversely, the training mode is considered to be “unsupervised” when the training data does not include any labels. Thus, the system may learn in an unsupervised manner if no labels are available, and therefore the system must learn the appropriate relationships between inputs and outputs entirely on its own. Results obtained during the training mode generally are not provided back to a host processing unit. Instead, the “output” of the training mode may be a trained neuromorphic computational model (or simply “trained model”) that is learned through study of the training data. FIG. 2 includes a diagrammatic illustration of the software pipeline 100 while in the training mode.

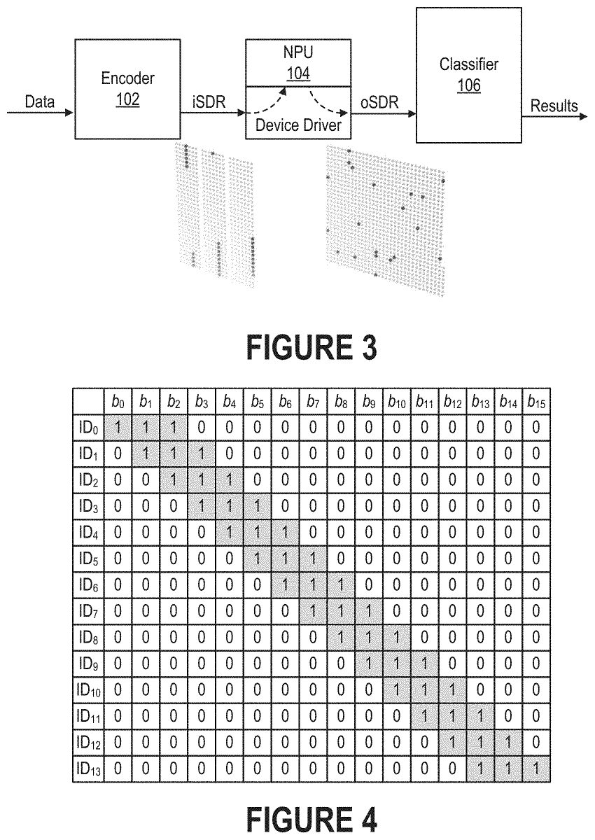

While in the inferencing mode, the system processes real-world data, rather than training data, through the software pipeline 100. Real-world data does not include labels, and therefore the system produces an output (also called an “inference” or “prediction”) based on relationships learned by studying the training data during the training mode. Said another way, the software pipeline 100—with the trained model learned in the training mode-can be used to predict appropriate labels for the real-world data. As part of the inferencing mode, the system can identify patterns in the real-world data and then create an appropriate SDR. Such an approach allows the classifier 106 to properly identify the labels that correspond to the input and provide those results to the host processing unit. Furthermore, the inferencing mode may allow the system to predict and learn changes in data patterns associated with the labels (e.g., to detect and address data “drift” over time). FIG. 3 includes a diagrammatic illustration of the software pipeline 100 while in the inferencing mode.

Continuous learning may be optionally permitted to let the trained model continue learning even as it is making inferences (e.g., based on analysis of real-world data or testing data). This may occur in scenarios where (i) the learning and inferencing rates of the trained model are similar and (ii) the trained model is capable of learning in unsupervised mode. Continuous learning allows the software pipeline 100 to learn new emerging classes, as well as track “drift” in the definition of learned classes, in real time.

### Overview of Encoder

Neuromorphic machine intelligence is a branch of AI in which models are derived based on a mathematical modeling of the cerebral neocortex of the human brain. These models can employ a form of data representation that is observed in nature by producing SDRs. With an SDR, a corresponding object is represented using a data structure (e.g., a binary vector) that is large but is relatively sparse. Said another way, the data structure may include hundreds or thousands entries, though only a small fraction (e.g., less than 5, 2, 1, or 0.5 percent) may be set bits. One important property of SDRs is that each position in the data structure has semantic meaning and represents a pseudo-orthogonal dimension in a high-dimension space. Another important property of SDRs is that the degree of overlap between a pair of SDRs is indicative of (e.g., proportional to) the degree of semantic similarity of the pair of objects represented by the pair of SDRs.

On the other hand, various problems and benchmarks in the field of AI represent objects as feature vectors. The term “feature vector” is generally used to refer to an ordered set of feature values of a corresponding object. The feature values are themselves represented in common datatypes used in computer science, such as integers, floating point numbers, characters, and the like. These representations are called “dense representations” because the focus tends to be the most efficient storage of these feature values. Consequently, these representations are typically short in length with no restrictions on sparsity. Additionally, the bit positions have no independent semantic meaning. Instead, the values in all of the bit positions are considered in combination to infer the value of a feature.

In order to solve standard problems and benchmarks in AI with neuromorphic models, an encoder (e.g., encoder 102 of FIG. 1) may be utilized to translate a representation of an object from the dense representation format to the SDR format. Introduced here is an encoder that can efficiently accomplish this, while also providing adjustable balance between resolution and desired overlap characteristics.

There are two known methods of encoding, namely, (i) linear encoding and (ii) random distributed encoding. With linear encoding, all of the b set bits are placed contiguously in an SDR of length l. Given a feature value f, a bucket identifier B can be calculated using min-max scaling followed by normalization to an integer value between 0 and l−B. FIG. 4 includes examples of linearly encoded SDRs for 14 possible bucket identifiers (i.e., ID₀-ID₁₃) using an SDR length of 16 bits (i.e., Bit₀-Bit₁₅) with 3 set bits. In FIG. 4, each SRD is listed as a row with the bucket identifier shown along the leftmost column.

Random distributed encoding generated a neighborhood around each bucket identifier B in such a way that neighborhoods of adjacent bucket identifiers have significant overlap. An l-bit encoding can then be generated based on the neighborhood of the bucket identifier. In contrast to linear encoding, the b set bits can be interspersed throughout the length of the SDR.

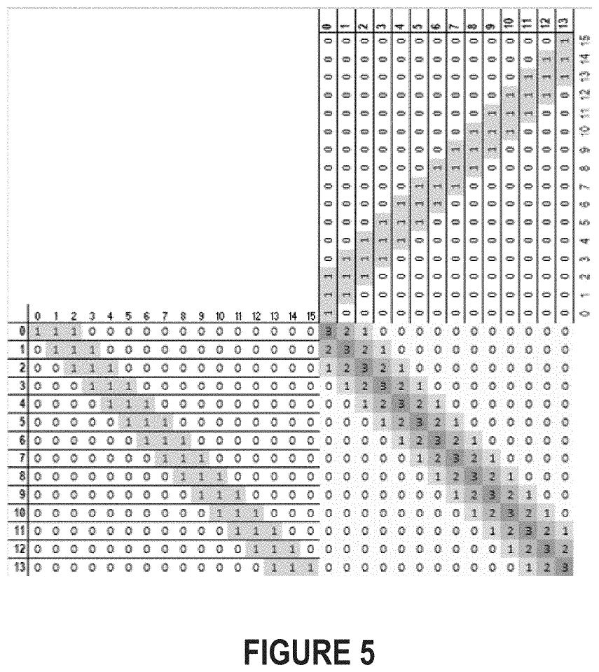

Linear encoding and random distributed encoding represent two ends of the spectrum with respect to the desired resolution and feature-SDR overlap characteristics. Linear encoding is more restrictive, offering a resolution of only l−b+1 buckets. However, linear encoding is very efficient with near constant runtime overhead. Additionally, there is no accidental overlap between the SDRs of different feature values. FIG. 5 shows the overlap between any pair of linearly encoded SDRs can be represented as a heat map graph (or simply “map”). In the map, the entry M_{i,j} represents the overlap scope between the SDRs of bucket identifiers i and j. The magnitude of the score is also captured in the different shades of the color used to show the overlap. Darker shades correspond to higher overlap. The map is symmetric about the diagonal because of the commutative property of calculating overlaps, namely, that M_{i,j} equals M_{j,i}. As can be seen in FIG. 5, the overlap is highest along the diagonal, as it represents the SDR overlapping itself. As the bucket identifier j moves away from i, the degree of overlap falls off linearly. This is the ideal behavior. On the other hand, random distributed encoding is less restrictive in terms of resolution, allowing all (_{b}^{l}) combinations of set bits in the SDRs, though it comes at the cost of possible accidental overlap. With random distributed encoding, the possibility of accidental overlap is unavoidable due to the pigeonhole principle. Runtime of a random distributed encoder is generally proportional to the size of the neighborhood that is used.

To overcome the challenge posed by balancing resolution and accidental overlap, the encoder introduced here may be adaptive in nature. The adaptive encoder provides a means to balance resolution with the likelihood of accidental overlap. The adaptive encoder can ensure that all of the set bits in the SDR provided to the NPU as input are always present within a span of s bits. Notice that by setting s=b, the adaptive encoder can work like a linear encoder. On the other extreme, the adaptive encoder can work like a random distributed encoder. As s increases from b towards l, the number of buckets increases combinatorically but so does the change of accidental overlap. This effect is discussed in greater detail below.=

Another feature of the adaptive encoder is the ability to algorithmically generate SDRs in a way that the SDRs of adjacent buckets will differ in exactly one position. This minimizes the nonlinearity in the overlap characteristics of the SDRs of buckets in a neighborhood but does not eliminate the nonlinearity completely. By combining linear encoding with random distributed encoding, the adaptive encoder can minimize nonregularities and localize accidental overlap to a minimum. Finally, the runtime complexity of the underlying algorithm may be proportional to the number of set bits, and therefore lies between that of linear encoding and random distributed encoding.

One innovation is to limit the b set bits in the SDR to a window spanning s bits. For convenience, s may be referred to as the “window span.” By doing this, a total of (_{b}^{s}) bucket identifiers can be encoded using SDRs whose set bits belong to the same window. Next, the window can shift by one position and the process can restart. In this manner, a total of (l−s+1)×(_{b}^{s}) bucket identifiers can be encoded. In some embodiments, the window span is predefined (i.e., programmed into memory and unchangeable). In other embodiments, the window span is a user-defined value where b≤s≤l.

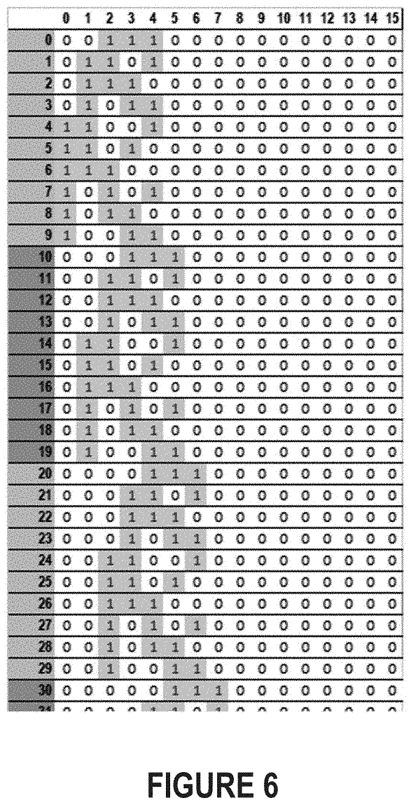

This approach to adaptively encoding bucket identifiers can proceed by identifying the window w in which a given bucket identifier lies and the offset position o within the window w. The underlying algorithm can initially generate an s-bit encoding of the offset o where b bits are set. Then, the underlying algorithm can shift the encoding w−1 times to generate the SDR. The b bits within a window can be set in such a way that the bit positions of adjacent bucket identifiers have a known overlap score (e.g., b−1). Furthermore, the SDR of the last bucket identifier of a window and the first bucket identifier of the next window may also differ in exactly one location. FIG. 6 illustrates how the aforementioned process can be employed with 16-bit SDRs where 3 bits are set within a span of 5 bits. In FIG. 6, each row represents a separate SDR with its bucket identifier shown in the leftmost column, which is shaded to indicate the bounds of windows. 10 SDRs

$$( i . e . , ( \begin{matrix}5 \\ 3\end{matrix} ) )$$

can be encoded in the first window spanning the initial 5 bits. The window can slide up to 12 times, allowing a resolution of 120 possible bucket identifiers. When the window span equals the number of set bits (i.e., s=b), the adaptive encoder can behave similar to a linear encoder. When the window span equals the length of the SDR (i.e., s=l), the adaptive encoder can behavior similar to a random distributed encoder.

Accidental overlap can be significantly reduced in comparison to pure random distributed encoding, yet it can still exist. For example, overlap between SDRs of buckets from the same window can be zero, when the span is more than two times the number of set bits b. However, overlap between SDRs of buckets from the next window can be as high as b−1, and the maximum possible overlap with the SDRs of the following window may be b−2 (and so on). Thus, the accidental overlap may become zero between bucket identifiers that are more than b windows apart.

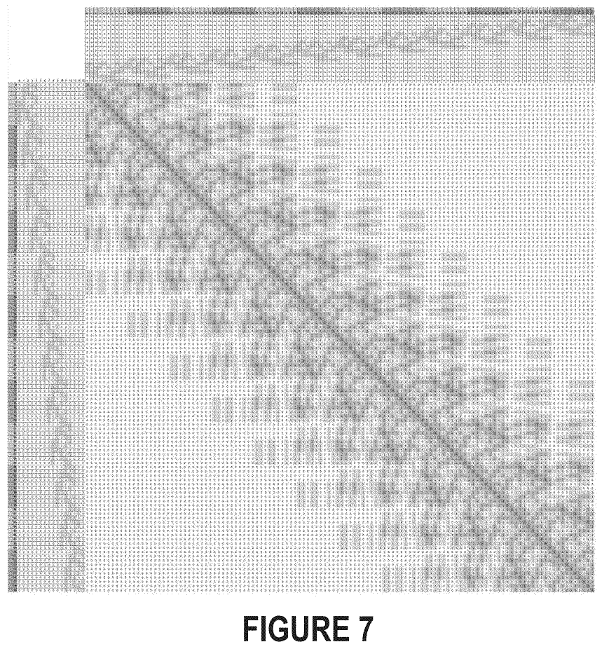

FIG. 7 includes a heat map graph (or simply “map”) that shows the degree of overlap between 120 SDRs by adaptive encoding in accordance with the aforementioned settings. The map follows the same conventions as discussed with reference to FIG. 5, namely, that each entry M_{i,j} in the map represents the degree of overlap between the SDRs of bucket identifiers i and j. In FIG. 7, the magnitude of the overlap is captured using different shades with darker shades representing higher overlap. As can be seen in FIG. 7, the map is symmetric about the diagonal with the diagonal elements having the highest possible overlap (here, of b=3) representing the SDR's overlap with itself. Further away from the diagonal, the overlap generally diminishes to zero, though the attenuation is not as ideal as when the adaptive encoder is in linear encoding mode as shown in FIG. 5.

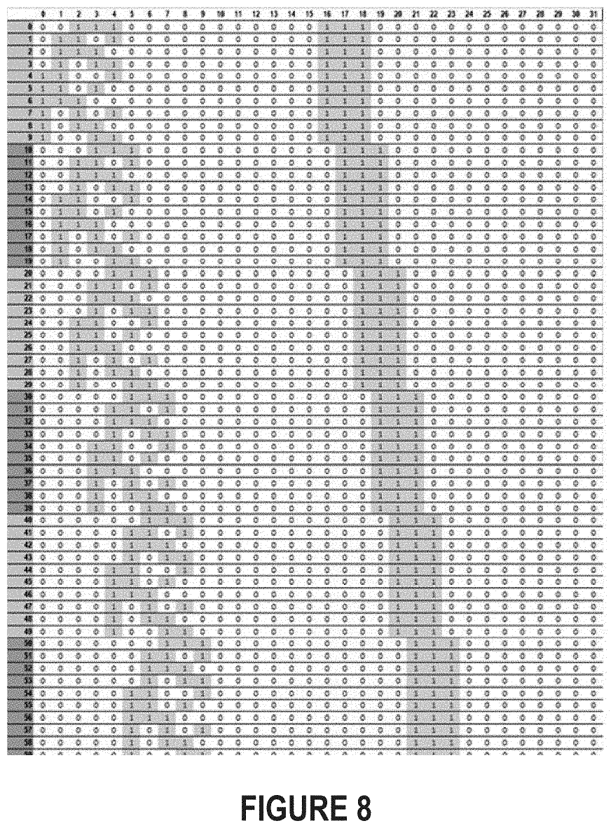

To further smooth the attenuation, a hybrid approach can be adopted. A second SDR of length l with b set fits can be generated for a given bucket identifier by linearly encoding its window w. The system can then append the two SDRs (i.e., the first SDR from adaptive encoding and the second SDR from linear encoding) to generate a composite SDR of length 2l bits, in which 2b bits are set. An example of encoding in accordance with this hybrid approach with an SDR length of 32 bits with 6 set bits is shown in FIG. 8.

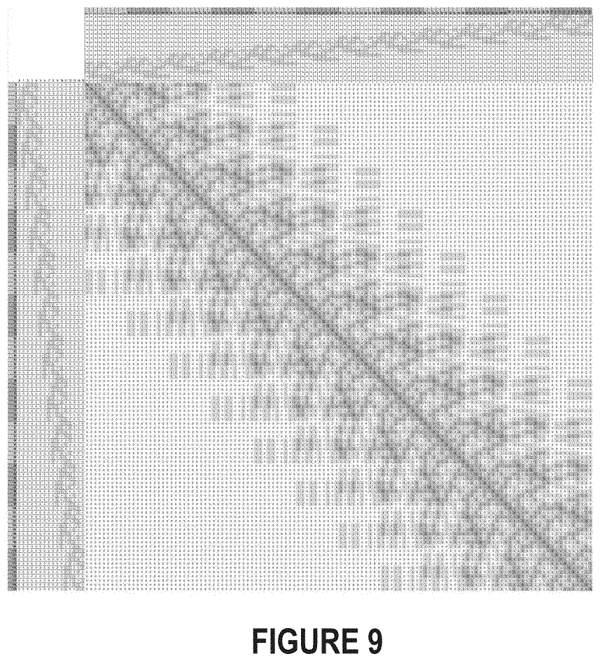

The overlap between the composite SDRs of bucket identifiers belonging to the same window lies between b bits (due to the linear encoding) and 2b−1 bits (with 0 to b−1 bits due to the adaptive encoding). The overlap between buckets lying in the next window lies between b−1 bits (due to the linear encoding) and 2b−2 bits (with 0 to b−1 bits due to the adaptive encoding). And the overlap between buckets lying in the next window lies between b−2 bits (due to the linear encoding) and 2b−4 bits (with 0 to b−2 bits due to the adaptive encoding). This pattern continues onward, between bucket identifiers that are more than b windows apart. FIG. 9 includes a heat map graph (or simply “map”) showing the degree of overlap between SDRs generated in accordance with the hybrid approach. Specifically, FIG. 9 includes a map of the overlap between the SDRs of 120 bucket identifiers generated through a combination of adaptive and linear encoding. The overlap characteristics are between those of the map produced for linear encoding shown in FIG. 5 and the map produced for adaptive encoding shown in FIG. 7.

The runtime complexity of the underlying algorithm executed by the system can be represented as 0 (b) . However, when (_{b}^{s}) is reasonably small, the w-bit encoding of all offsets within a window can be precalculated and stored in memory. The rest of the operations (e.g., the shift operation and linear encoding of the window) can be generated using constant runtime complexity. In either case, the runtime complexity of the underlying algorithm allows encoding to occur in real time for highly accelerated computational systems.

### Processing Vectors in the NPU

Representing objects and class signatures as sparse high-dimensional vectors (e.g., hyperdimensional vectors) is done by some computational systems where the vectors can be represented as the collection of indices of its set bits. This type of representation allows for compaction of storage as the vectors are typically very sparse with less than 2 percent of bits set. For example, a 1,024-bit vector with 40 set bits can be represented using 128 bytes in the native bit-vector format or 80 bytes when storing just the indices of set bits, where each index is represented using 2 bytes. This results in a 37.5 percent reduction in space required.

This approach can be employed to gain significant benefits in the system introduced here. The software pipeline (e.g., the software pipeline 100 of FIG. 1) can employ a novel processing architecture to accelerate its most critical stage from a performance perspective—the learning stage in which a model is learned. For example, the system may include a Natural Neural Processor (NNP) that has a streaming-based, reconfigurable, non-von Neumann and Multiple Instruction Single Data (MISD) architecture. Its constituent parts, functionality, performance bottlenecks, and advantages are different than convention processing architectures, such as CPUs and GPUs. Representing SDRs as ordered sets of indices may allow the rest of the software pipeline to keep pace with an NNP.

The computational complexity of the three stages of the software pipeline is summarized as follows.

The first stage (also called the “encoding stage”) can execute on a host processing unit efficiently. The host processing unit could be a CPU, for example. The encoding stage may be carefully designed to have a runtime complexity of 0(b), where b is the number of set bits in the input SDR (iSDR). The output may already be sorted, and therefore can avoid the overheard of 0(b log b) of sorting the result. Similarly, the output may already be in the compact format that the second stage (also called the “learning stage”) ingests. Otherwise, the compaction may add complexity of overhead cost 0(l), where l is the length of the iSDR and b«1. With this low complexity and faster operating clock frequency, the encoding stage can keep pace with the subsequent stages of the software pipeline.

The learning stage—in which a model is learned through analysis of training data—can be executed on an NPU, which may be a subcomponent of the NNP. The model can include a collection of neurons and feedforward synapses, which are intended to mimic the pyramidal neurons and proximal synapses in the neocortex of the human brain. The feedforward synapses can be connected to various offset locations in the iSDRs. Based on the feedforward synapses and set bits in the iSDR, the NPU can compute a weighted overlap score for each neuron. The weighted overlap scores can then be used to identify “winning neurons.” The indices of neurons may represent the output SDR (oSDR) of the learning stage.

The NPU can be connected to the host processing unit (e.g., a CPU) using a streaming interconnect, such as a PCI Express (PCle) interface, that allows the passage of iSDRs and oSDRs between the NPU and host processing unit. The compact nature of iSDRs and oSDRs can reduce the streaming bandwidth and onboard memory requirements by roughly 37 percent as discussed above. More importantly, the compact nature may align with the processing of the simple pattern matching neurons to the NPU architecture. This allows a very dense and efficient realization of neurons in the NPU, which enables reduced latency, die area, and energy requirements while increasing throughput and efficiency. Each neuron may have Synaptic Strength Value Memory (SSVM) to track the connection strength of the synapses. By broadcasting only the unordered SDR bits to all of the neurons in parallel using the MISD architecture of the NPU, each neuron can respond to those set bits if the NPU has been programmed to recognize. The NPU can then calculate an overlap score for each neuron to determine the “winning neurons.”

In embodiments where “winning neurons” are determined, passing an iSDR as an unordered collection of indices of its set bits is particularly beneficial. There is no requirement that the collection be ordered. The indices can be changed into a symbol stream, where each symbol corresponds to an index in the collection. After processing the last symbol of the iSDR, the overlap scores of the neurons can be captured and additional logic circuitry may be used to efficiently identify the “winning neurons.” The overall efficiency of this embodiment allows for the execution of thousands of neurons on a single computing device, at very low power, in very small die size, and with high clock speeds. This combination can produce performance gains that are several orders of magnitude better than conventional solutions.

The output SDR (oSDR) of the learning stage can also be an iSDR for subsequent instances of the learning stage without any modifications. The oSDR may also be represented as an unordered collection of set bits. Therefore, models can be sequentially arranged in any hierarchical order to provide higher order processing capabilities with very little overhead. oSDRs that are represented in this manner can also be used in the third stage (also called the “classifying stage”) for learning class signatures and matching against previously learned class signatures for inference purposes. Matching against prior class signatures can be significantly accelerated by comparing only the set bits in an oSDR to those in the class signatures. Each class signature can be maintained as an ordered collection of indices of its set bits. This reduces the complexity to b log l_{sign}, where l_{sign} is the length of the signature SDRs.

### Handling Missing Feature Values With SDRs

Set forth below is a discussion on how to handle missing values using SDRs and a cortical artificial intelligence system (or simply “system”) that is intuitive to understand, simple to compute, and portable from one application to another. The method for handling missing feature values is an important part of the strategy for semantically encoding various data types into the SDR to provide a meaningful input to the model. Handling missing feature values may be a part of all encoding strategies for iSDRs to which the model is applied and represents the strategy of encoding null semantic information for an individual field where the system recognizes the absence of data.

This approach combines the implementation of a cortical processing model based on several neocortical concepts, the understanding of its mathematical properties and that of its data representation (i.e., the SDR), combined with practical methods to encode missing feature values using null semantics.

The first fundamental concept is the mathematical properties of sparse hyperdimensional data representation called SDR. As mentioned above, an SDR can capture combinations of subtle semantics that represent the input data. The high dimensionality and low sparsity provide mathematical guarantees that two arbitrary SDRs will be spatially distant from one another-and likely very spatially distant from one another—unless those SDRs are noisy variants of each other. As an example, it can be mathematically shown in a 2,048-bit input SDR with 40 set bits representing encoded semantics that the change of misclassification is less than e⁻¹⁵ even when 50 percent of the expected 40 set bits are missing in the SDR.

The second fundamental concept relates to the use of an unsupervised brain-inspired learning algorithm (or simply “algorithm”) that can identify combinations of semantics that occur concurrently and/or frequently. The algorithm can be built using an array of neurons that are intended to represent the “pyramidal neurons” in the neocortex of the human brain. These neurons can be connected to a subset of iSDR bit positions. Therefore, each of the iSDR bit positions may be connected to very few neurons, and the effect of a null value in a given field of an iSDR may be limited to only those neurons and not propagated throughout the model, like it would in a conventional ML model.

One aspect that arises from the properties of the SDR and the working of the model is that missing values are generally not a concern for the system. Zero-value bits (i.e., 0-bits) in the input SDR do not necessarily signify that the value is zero. It merely signifies that information about that semantic is missing or absent in the input SDR. The mathematical properties of the input SDR and the working of the NPU makes the system tolerant to a large number of missing one-value bits (i.e., 1-bits).

This leads to the method of encoding missing feature values in traditional AI datasets for computation in the model. A variety of encoding techniques can be used to encode each feature individually into feature SDRs, which can then be converted into a composite input SDR using simple operations such as concatenation. When the value for a feature is missing, it can be encoded as a feature vector with no 1-bits. This corresponds to the second native interpretation of a 0-bit in an SDR (i.e., that the information is missing). As long as the number of missing feature values is not very large, the model can continue to learn and infer the correct patterns in the training data.

While encoding input SDR bits with zeros is simple in concept, the combination of the mathematical properties of the sparse hyperdimensional data representation and the operations of a sparsely connected, neocortically inspired learning algorithm permit handling missing data in an intuitive fashion while continuing to enable highly accurate predictions.

### Generating the Output Sparse Distributed Representation (oSDR)

The output data, from the NPU, can be processed to determine the “winning neurons” and format these outputs into the proper form for the oSDR. Whether it is a single- or multi-NPU system, this function can be performed in various ways. For example, this function can be performed via execution of software by the device driver of the NPU, or this function can be performed by an on-board microprocessor or a hardware module that is added to the NPU. In some embodiments, the device driver processes outputs produced by the NPU and constructs oSDRs.

At a high level, the NPU may be a digital representation of a feedforward neuron and can be embodied in software, firmware, or hardware. Examples of hardware-based NPUs are described in U.S. application Ser. No. 17/531,576, which is incorporated by reference herein in its entirety. Regardless of its implementation, for each iSDR, the NPU can calculate its overlap count (OLC) between its synapses and the iSDR. The overall system can include hundreds or thousands of NPUs that compute their respective OLCs independently. This provides an opportunity to parallelize this operation, especially in hardware, giving high efficiency and speed. To generate the final oSDR, the NPUs can be ordered based on their OLCs. The NPUs with the highest OLCs can be declared “winners” for that iSDR. This winner selection process can also be streamlined for efficient hardware implementation.

In the inferencing mode, the identifier of the winning NPUs can server as the oSDR. By restricting the winning NPUs to a small percentage of the overall number of NPUs (e.g., 0.5, 1, or 5 percent), the desired sparsity of the oSDR can be attained. In the inferencing mode, the oSDR can be fed to the next stage of the software pipeline, namely, the classifying stage. The processing of the next iSDR can start immediately. However, in the learning stage, an additional step may be required. The synaptic strengths of the winning NPUs may need to be adjusted, for example, in accordance with Hebbian enforcement rules, to reflect the learning of the NPU after processing the iSDR.

### Aggregation of Potential Winning Neurons

The NPU may employ a value-sorting algorithm (or simply “sorting algorithm”) that produces a list of potential winning neurons based on an analysis of the OLCs. In some instances, this list is likely not the list of actual winning neurons. For example, a multi-NPU system can identify more potential winning neurons than the system is designed to produce. Furthermore, the automatic updating of Synaptic Strength Values (SSVs), stored in the Synaptic Strength Memory (SSM), and the automatic adjusting of Boost Factors (BFs) may not occur until the NPU is notified of its actual winning neurons.

Systems designed for AI and ML may incorporate more than one NPU. For example, two or more NPUs can be designed into such a system. These multiple NPUs may be on a single printed circuit board assembly (PCBA), or these multiple NPUs may be on multiple PCBAs. For example, the system might include two PCIe NPU PCAs, and each PCA may include eight NPUs, so the entire system may include sixteen NPUs. This approach solves the problem of determining which neurons are the actual winning neurons, notifying the various NPUs in the system of their winning neurons, if any, and constructing and transmitting the oSDR to the host processing unit.

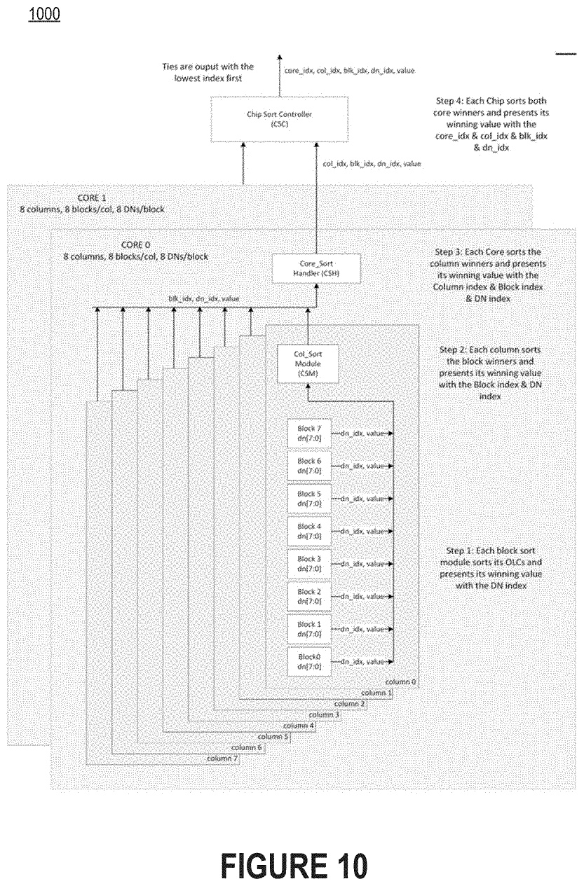

FIG. 10 includes an overview of the sorting process 1000 by which winning neurons can be identified by the NPU. The sorting process 1000 can include four steps. At step one, each block sort module of each NPU can initially sort its OLCs and then present its winning value with the neuron index. At step two, each column can sort the block winners and then present the winning value with the block index and neuron index. At step three, each core can sort the column winners and then present its winning value with the column index, block index, and neuron index. At step four, each chip can sort the core winners and then present the winning value with the core index, column index, block index, and neuron index.

As shown in FIG. 10, the output of the process 1000—produced by the Chip Sort Controller (CSC)—may be an ordered list, from highest OLC value to lowest OLC value. Ties can be output in a known and predictable order. Normally, this list includes exactly the number of winning neurons that are prescribed by the application—a configuration setting that can be programmed in the NPU. However, this list can be complicated by several things.

A system might contain any number of NPUs. However, the system can also specify the number of winning neurons that can be identified, during the processing of any given iSDR. In a multi-NPU system, one way to guarantee the delivery of the desired number of winning neurons is to allow each NPU to output up to the total desired number of winning neurons. The output of these NPUs, known as potential winning neurons, may be multiple times the total number of winning neurons desired by the system. All of the potential winning neurons can be collected and sorted, in order of count value, and the desired number of winning neurons can be chosen from the top count values in the ordered list.

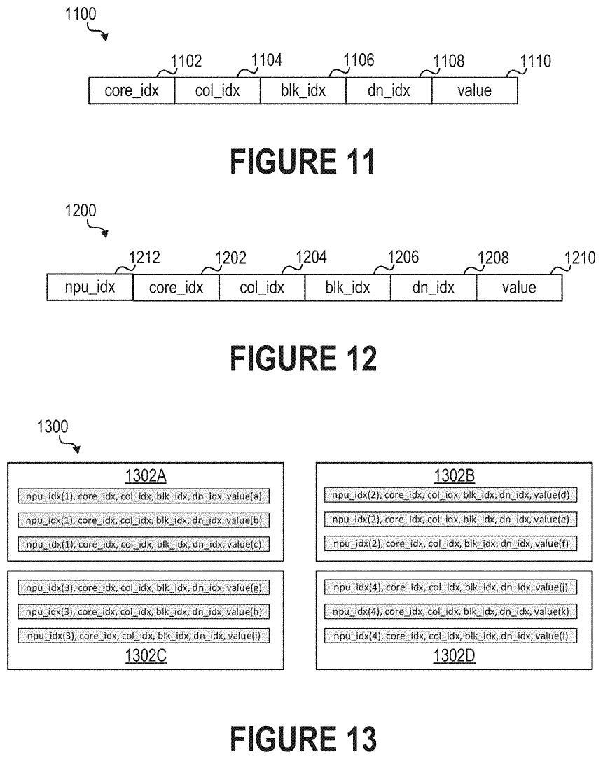

Each NPU can then be notified of its neurons, if any, that were determined to be actual or true winners. Each NPU can be prepared to update SSVs and BFs, as necessary. Note that the data output by each NPU can include more than just the OLC value. The data may also include information to permit correctly identifying the neuron, as shown in FIG. 11. For example, the data can include the physical address of the neuron inside the NPU. In FIG. 11, the data 1100 includes the core index 1102, column index 1104, block index 1106, neuron index 1108, and value 1110.

Data corresponding to potential winning neurons can have another field added, so as to identify the NPU that produced the data. FIG. 12 includes an example of the data 1200 with an NPU index 1212 added. As shown in FIG. 12, the data 1200 may be otherwise similar to the data 1100 shown in FIG. 11. Thus, the data 1200 may include the core index 1202, column index 1204, block index 1206, neuron index 1208, and value 1210.

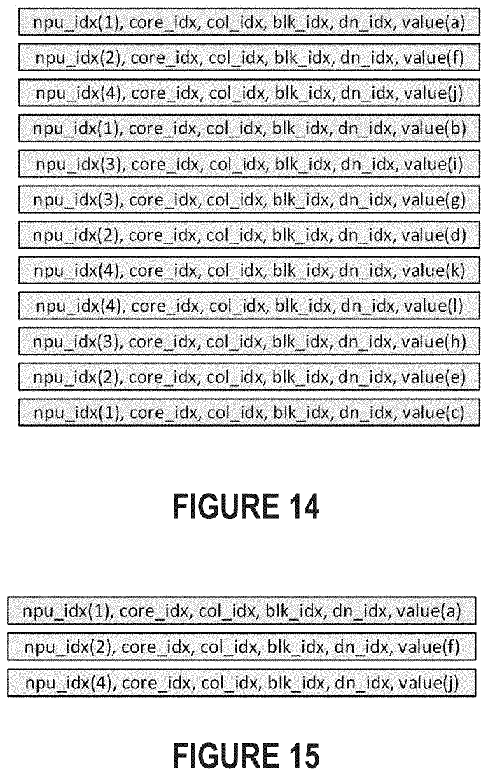

FIG. 13 includes an example of a multi-NPU system 1300 in which an oSDR is requested of three winning neurons. In this example, the system 1300 includes four NPUs 1302A-D. Other embodiments of the system 1300 could include more or less than four NPUs. The system 1300 is designed to output three winning neurons. Therefore, each NPU 1302A-D may output its top three neurons on the ordered list as potential winning neurons. For the purpose of illustration, the output of each NPU his colored to indicate sorting. The sorted output of the NPUs 1302A-D appears as shown in FIG. 14, assuming OLC values of a>f>j>b>i>g>d>k>l>h>e>c. The three true winners are shown in FIG. 15.

NPUs with NPU indices corresponding to the actual winning neurons, namely, with values of npu_index(1), npu_index(2), and npu_index(4), can be notified that each has one winning neuron. These NPUs can then update their respective SSVs and BFs, as appropriate.

The true winning neurons can then be processed, as necessary, to become the oSDR to be transmitted to the host processing unit. In this example, the three winning neurons with values of npu_index(1), npu_index(2), and npu_index(4) can be processed or encoded, as necessary, to become the oSDR. In FIGS. 13-15, the identification of the physical location of a given neuron is shown as (npu_idx, core_idx, col_idx, blk_idx, dn_idx, value). This form conforms to the architecture of the NPU—neurons, blocks, columns, cores, and NPUs—though this form can change.

### Classification of the Output of the Neural Processing Unit (NPU)

As mentioned above, the model may be a neuromorphic learning model that processes a sparse bit vector—called the iSDR—as input and then generated another sparse bit vector—called the oSDR—as output. One contribution of the model is that the oSDR is more readily classifiable than the iSDR (and at lower computational complexity). During the training mode, the oSDRs can be used to build class definitions for inferencing thereafter. Conversely, during the inferencing mode (or testing mode following the training mode), the oSDRs can be used to predict the class of each sample. In the case of continuous learning, every sample can be used for testing and training, and therefore both operations may be performed. These operations can be carried out during the last stage of the software pipeline, namely, the classifying stage.

The supervised classification technique described below includes the concept of subclasses, creating fine-grained decision boundaries within classes and allowing the overall software pipeline to meet the requirements of sophisticated AI applications. In developing the classifier (e.g., the classifier 106 of FIG. 1), there are various considerations. First, classification should be fast, allowing the classifying stage to keep up with the accelerated processing rate and low latency of the other stages of the software pipeline. Second, the class and subclass representations should maintain the mathematical properties of the SDR representation. This allows the overall software pipeline to maintain noise resilience and low-shot learning capability. Third, the classifier, and therefore the overall system, should be able to incrementally and independently learn new classes or subclasses on the fly without disturbing already learned classifications. Fourth, the classifier should be able to track and learn drift with respect to the definitions of existing classifications over time, without disturbing the definitions of other leaned classes or subclasses. Fifth, each definition of a class or subclass should be semantically explainable as an intuitive combination of range of values of a feature of a sample, by tracing that sample back through previous stages in the software pipeline.

These considerations take into account the mathematical properties of SDRs, which dictate that the probability of significant overlap between any two unrelated SDRs should be infinitesimally small. Also, by the very nature and design of the model, the oSDRs that are generated for samples of the same class should be very similar in their set bits. The intuitive and effective characteristics of oSDRs output by the system allows the system to meet the five criteria specified above.

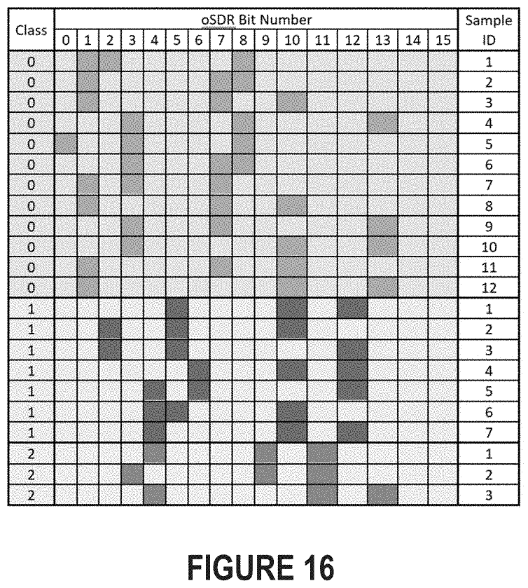

To illustrate the working of the classifier, an illustrative example is described in the context of the training data shown in FIG. 16. Specifically, FIG. 16 includes the oSDRs of training samples in three separate classes, namely, Class 0, Class 1, and Class 2. In FIG. 16, the oSDR of each training sample is 16 bits long with 3 set bits. Each row in the table corresponds to a separate oSDR. The training data includes a total of 22 samples: (i) 12 samples that belong to Class 0, (ii) 7 samples that belong to Class 1, and (iii) 3 samples that belong to Class 2. The first 12 rows show the oSDRs that belong to the 12 samples from Class 0, denoted by the label of “0” that is placed in the leftmost column. The number in the rightmost column is the identifier used to reference the sample. In FIG. 16, the darker coloration depicts the set bits in each oSDR. For example, the oSDR of Sample ID 1 of Class 0 has set bits at offset locations 1, 2, and 8. For succinctness, this oSDR can be denoted using the set notation of {1,2,8}. The next seven rows represent oSDRs from Class 1, and the following three rows represent the oSDRs from Class 2.

### Supervised Classification for Explainable AI with Continuous Learning

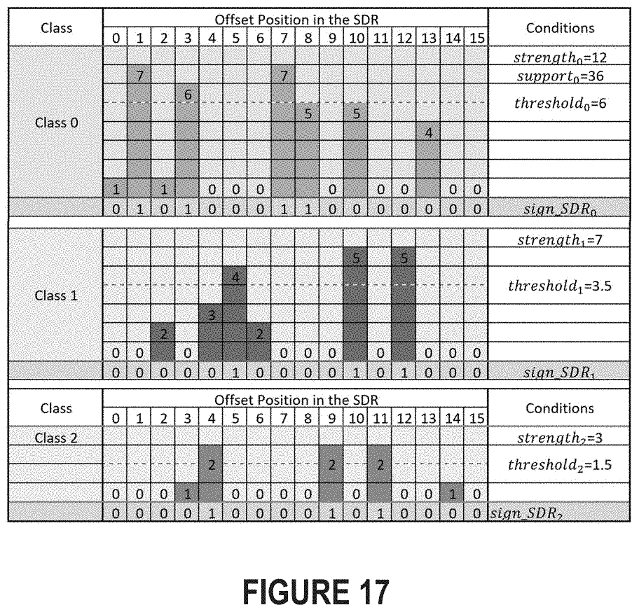

During the training mode, a data structure can be created for each class by the classifier. For example, for each class, the classifier may create a lookup table that is representative of a histogram of set-bit locations (i.e., offsets) in the oSDRs of that class. Each column in the histogram can correspond to an offset position in the oSDRs. The height hi of a column depicts the number of times that offset position j was set in the oSDRs of training samples from class i. For example, referring to FIG. 17, the height of the column corresponding to the first offset position is seven (i.e., h₀¹=7).

FIG. 17 shows histograms that have been produced for Class 0, Class 1, and Class 2 for the training data described with respect to FIG. 16. A signature SDR can be created for each class based on the histogram. In order to generate this signature SDR, a threshold value may initially be generated by multiplying the strength of each class with a multiplier value. The strength of a class i is the number of samples in that class, while the multiplier value may be defined by a user or determined by the system. The histogram for each class can then be used by the classifier to generate the signature SDR, by identifying the columns in the histogram whose height is greater than or equal to the threshold value. Offsets in the signature SDR that satisfy the threshold value can be set to a value of one, while all other offsets can be set to a value of zero. FIG. 17 illustrates this process with a multiplier value of 0.5.

Pseudocode for an example of an algorithm that could be employed by the classifier to produce signature SDRs is presented below. The pseudocode includes two subroutines, namely, a first subroutine (i.e., calc_histogram) for calculating histograms and a second subroutine (i.e., calc_sign_SDRs) for calculating signature SDRs. In batch mode, the runtime complexity of the second subroutine is:

O(((|Training Set|×oSDR_num_set_bits)+(num_classes×oSDR_len)),

where |Training Set|denotes the number of samples in the training data, oSDR_num_set_bits denotes the number of set bits in each oSDR, num_classes denotes the number of classes, and oSDR_len denotes the length of each oSDR. The first part of the sum comes from the runtime complexity of the first subroutine. The second part of the sum comes from the complexity of calculating the signature SDRs designated as the array sign_SDRs. Typically, the first part of the sum is much larger than the second part of the sum for large amounts of training data (e.g., with many samples).

```
calc_histogram(training_set, num_classes, oSDR_len)
    Initialize hᵢ^{j} = 0, ∀ 0 ≤ i < num_classes; 0 ≤ j < oSDR_len
    for class, T′ ∈ training_set do
        h_{class}^{j} = h_{class}^{j} + 1, ∀ j ∈ T′
    return array h and vector support
calc_sign_SDRs(training_set, num_classes, oSDR_len, multiplier)
    h = calc_historgram(training_set, num_classes, oSDR_len)
    for i ∈ [0, num_classes) do
      strengthᵢ = 0
      sign_SDRᵢ = ∅
    for class, T′ ∈ training_set do
      strength_{class} = strength_{class} + 1
    for i ∈ [0, num_classes) do
      thresholdᵢ = strengthᵢ × multiplier
      for j ∈ [0, oSDR_len) do
          if hᵢ^{j} ≤ thresholdᵢ do
              sign_SDRᵢ = sign_SDRᵢ ∪ {j}
    return array sign_SDR
```

In streaming mode, the algorithm can be changed slightly to update the histogram and threshold of only the class that the sample belongs to. This can be accomplished in 0(oSDR_num_set_bits) complexity. Similarly, the update to the array can be limited to the signature SDR of only the class to which the sample belongs. This can be accomplished in 0(oSDR_len) complexity. Therefore, the overall complexity of handling each sample in the training data may be 0(oSDR_len). Thus, the overall complexity may be proportional to the number of set bits in the oSDR.

For a test oSDR, an overlap score can be calculated for each class by counting the common offsets of the test oSDR with the signature SDR of each class. The class with the highest overlap score can be declared the winner. Ties can be reported and/or resolved arbitrarily. Pseudocode for an algorithm for determining the classification of an oSDR created for a test sample is below. The runtime complexity of the algorithm is 0(num_classes×oSDR_num_set_bits).

```
class_f labor_2(T, num_classes, oSDR_len)
    for i ∈ [0, num_classes) do
        overlapᵢ = |T ∩ sign_SDRᵢ|
    identify winner ∈ [0, num_classes) where overlap_{winner}is highest
    return winner
```

In the case of continuous learning, runtime complexity of determining the predicted class of a test oSDR and updating the signature SDR of the predicted class is 0(num_classes×oSDR_num_set_bits)+0(oSDR_len)=0(num_classes×oSDR_num_set_bits). As the number of classes increase, the runtime can grow proportionally, though the runtime could be accelerated with custom hardware. Fortunately, this problem is parallel, and the runtime complexity can be decreased to

$$O ( \frac{{num}_{classes}}{p} \times oSDR\_num \_set \_bits ) ,$$

where p is the number of threads that can be executed in parallel.

The approach to classification introduced here can satisfy the conditions set forth above. The approach is able to maintain a definition of a class as its signature, which is defined as an SDR. By choosing a suitable multiplier value, the sparsity of the signature SDRs can be help sufficiently low, guaranteeing low-shot and noise-resilient learning capabilities as mathematical properties. These signature SDRs can be easily explained in terms of combination of ranges of feature values that the corresponding classes are receptive to, using the synaptic map of the neuromorphic model. The description of this explainability is covered further below. It can support continuous learning with low runtime complexity and memory requirements as discussed above. Moreover, learning a new class and its signature SDR can be done instantaneously, incrementally, and independently of the definitions determined for existing classes. Similarly, if the definition of an existing class begins to drift-as signified by drift in the set bits of the oSDRs of samples belonging to the existing class—then the signature SDR can be automatically updated to account for the drift. Again, the computation may be incremental and independent of the definition of other classes, allowing for continuous learning in real time.

Below, the fundamentals of classification—as performed using an NPU—are set forth in the context of a set of training data, as well as the approach to building the histograms. Here, a method for dealing with subclasses is also presented. For the purpose of illustration, the training data shown in FIG. 16 is used in this example.

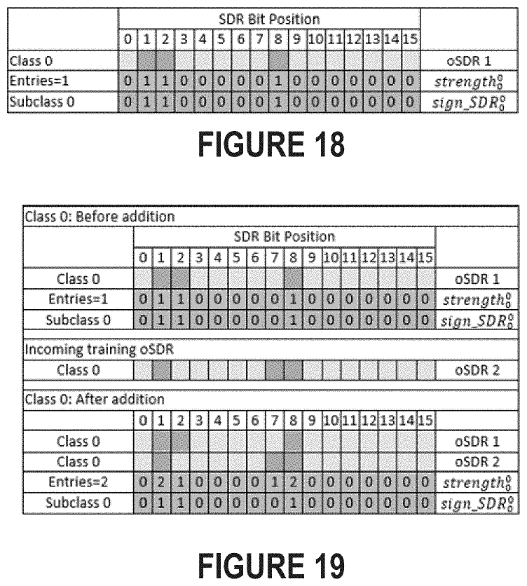

The number of entries that are included in a class's subclasses can be used as an indicator of the strength of each subclass. The number of entries is representative of the number of oSDRs that have contributed to each subclass. FIG. 18 shows how the system may handle the first training oSDR of Class 0. There are no existing subclasses within Class 0. Therefore, a new subclass is created and the first training oSDR is inserted as the first member of the new subclass. The signature of the new subclass can be defined as the oSDR of the first training sample.

Processing subsequent training oSDRs belonging to the new subclass involves several steps. First, a training oSDR may be compared with the signature SDRs of existing subclasses, which in this case is Subclass 0. The subclass whose signature SDR has the highest overlap with the training oSDR can be chosen if the OLC value is higher than an entry threshold, which may be defined by a user. The entry threshold can be expressed as a percentage of the number of set bits in the training oSDR. In this example, the entry threshold is set to 66 percent, which leads to a minimum OLC value of 2 (i.e., the entry threshold multiplied by the number of set bits in the training oSDRs, or 0.66×3).

FIG. 19 illustrates how the second training oSDR corresponding to Class 0 can be handled. First, its OLC value with respect to the signature SDRs of all existing subclasses of Class 0 can be calculated. The subclass with the highest OLC value can be selected as the winner. In the case of a tie for the highest OLC value, the subclass with the lowest number of entries may be selected. In this example, the second training oSDR has an overlap in two bit positions with the first subclass (i.e., Subclass 0). This OLC value satisfies the entry threshold, and there are no ties. Therefore, the second training oSDR may be added to SubClass 0 of Class 0.

The signature of Class 0 can be updated after the addition. While updating the signature, the support for each offset location from members of that subclass can be considered. Generally, the offsets with the highest strength are included. If, while adding offsets to the signature, the sparsity increases beyond a stipulated amount, then ties can be broken with a bias towards retaining the old signature. This scenario is illustrated in the case of offsets 2 and 7, both of which are supported by one member of the subclass. However, offset 2 is retained in the signature because of the bias.

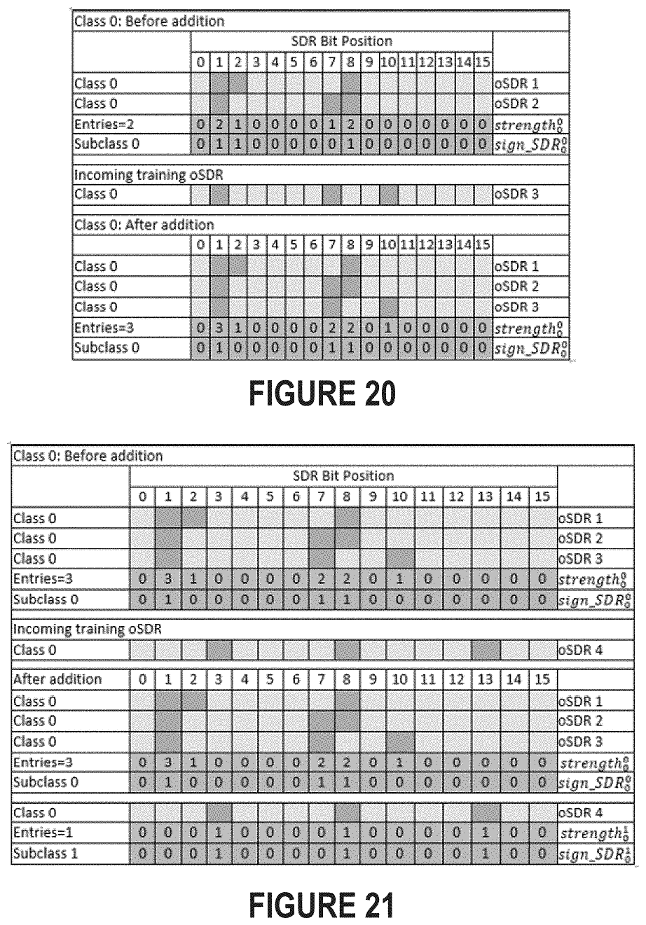

FIG. 20 illustrates how to handle a third training oSDR corresponding to Class 0. Like the second training oSDR, the third training oSDR meets the entry threshold for addition to SubClass 0 of Class 0 and there are no ties. However, after the addition of the third training oSDR, the signature SDR of SubClass 0 changes from {1,2,8} to {1,7,8} based on the strength of the offsets, as discussed above.

FIG. 21 illustrates how to handle a fourth training oSDR corresponding to Class 0. In this situation, the maximum overlap with signatures of SubClass 0 (i.e., the only subclass) of Class 0 is one. This is below the entry threshold, and therefore a new subclass, namely, Subclass 1, is created with the fourth training oSDR as its first member. The signature SDR for Subclass 1 can be generated based on the fourth training oSDR.

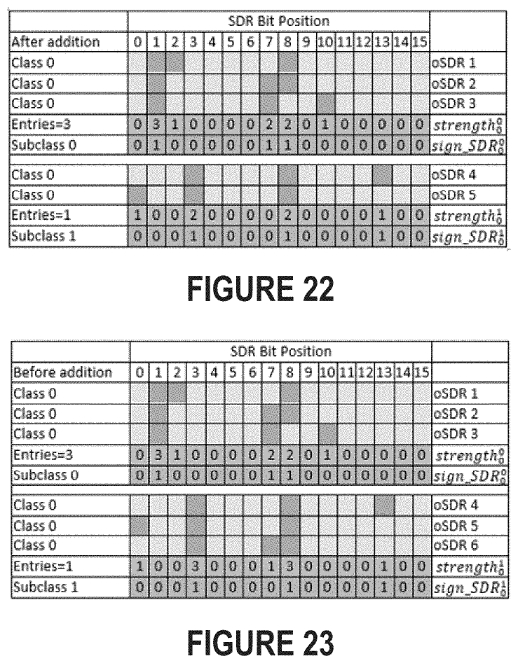

Continuing in this fashion, FIG. 22 shows the effects of processing a fifth training oSDR corresponding to Class 0. Note that the tie—between bit 0 (strength=1) and bit 13 (strength=1) in the signature SDR for Subclass 1—can be resolved by a tiebreak rule, such that the earliest oSDR wins. In this example, bit 13 is entered into the SDR.

FIG. 23 shows the effects of processing a sixth training oSDR corresponding to Class 0. When the sixth training oSDR is handled, it has an OLC value of two with the signature SDRs of SubClass 0 and Subclass 1 of Class 0. However, because the strength of Subclass 1 (strength=2) is less than the strength of SubClass 0 (strength=3), the sixth training oSDR is entered into Subclass 1 in accordance with the tiebreaking strategy set forth above. Note that there is a three-way tie—between bit 0, bit 7, and bit 13 (all having strength=1)—in the signature SDR for Subclass 1. Again, the tie can be resolved by the rule that the earliest oSDR wins. Thus, bit 13 is entered into the SDR.

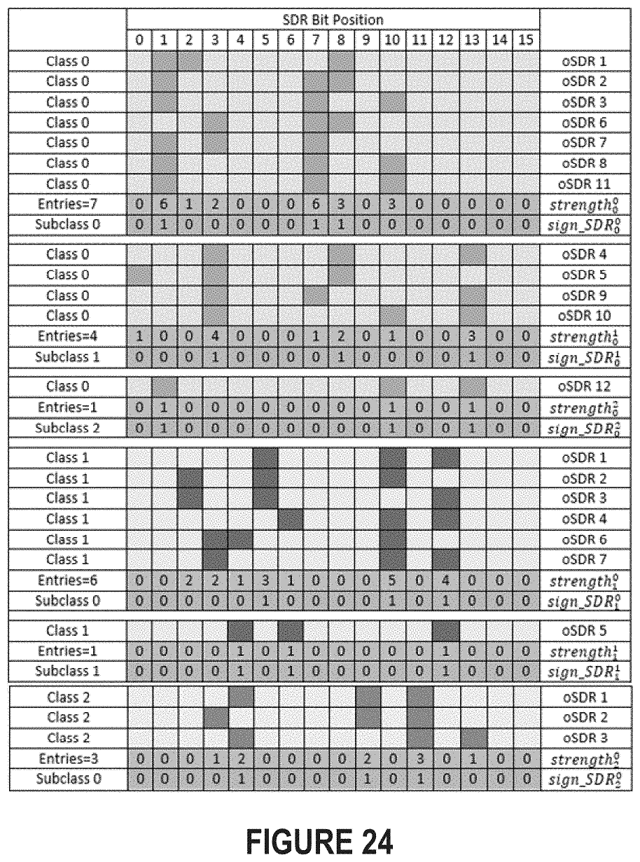

FIG. 24 shows all of the subclasses that are formed after processing all of the training oSDRs for Class 0, Class 1, and Class 2 as shown in FIG. 16.

Pseudocode for the algorithm for forming subclasses is presented below. Here, sign_SDR denotes an array of signature SDRs whose element from the i^{th} row and j^{th} column captures the signature SDR of the j^{th} subclass of class i, and is denoted as sign_SDRᵢ^{j}. The element sign_SDRᵢ^{j} is in turn defined as a linked list of oSDRₗₑₙ tuples. Each tuple can have two parameters-offset and strength-that denote an offset in the signature SDR and its associated strength. In other words, the tuple {k, strerngthᵢ^{j}[k]} corresponds to the k^{th} offset in the signature SDR and stores its strength (i.e., strengthᵢ^{j}[k]). The tuples in the linked list can be arranged in ascending order in terms of the strength parameter. This helps in the efficient addition and deletion of offsets in the signature SDR.

```
    calc_adp_sub_sign_SDRs(training_set, num_classes, entry_threshold)
    for i ∈ [0, num_classes) do
    Comment: Initialization
    num_subclassesᵢ = 0
    for class, T′ ∈ training_set do
    Calculate overlap_{class}^{j} = |T′ ∩ sign_SDR_{class}^{j}| ∀ j
              ∈ [0, num_subclasses_{class})
    Identify max such that overlap_{class}^{max} = max(overlap_{class}^{j}) ∀ j
              ∈ [0, num_subclasses_{class})
Comment: If there is a tie, resolve max such that num_entries_{class}^{max} is minimum.
    if overlap_{class}^{max} < entry_threshold then
    Comment: Create New Subclass
    forall k ∈ T′
    strength_{class}^{max}[k] = 1
    push tuple{k,1} to the front of the list sign_SDR_{class}^{num}_subclasses_{_{class}}
    num_entries_{class}^{num}_subclasses_{_{class}} = num_entries_{class}^{num}_subclasses_{_{class}} + 1
    num_subclasses_{class} = num_entries_{class} + 1
    else
    Comment: Add to existing subclass and update signature
    num_entries_{class}^{max} = num_entries_{class}^{max} + 1
    for all k ∈ T′
    strength_{class}^{max}[k] = strength_{class}^{max}[k] + 1
    Assign strength parameter of first node in sign_SDR_{class}^{max} to min_strrength_{class}^{max}
    if strengthen_{class}^{max}[k] > min_strengthen_{class}^{max} then
    Pop first node in sign_SDR_{class}^{max}
    Insert tuple {k, strengthens_{class}^{max}[k]} in ascending order to sign_SDR_{class}^{max}
    return sign_SDR
```

In batch mode, the runtime complexity of the algorithm subroutine (i.e., that of the training phase) is 0(|training_set|×num_subclasses_{avg}×oSDR_num_set_bits). Here, |training_set| denotes the number of samples in the training data, num_subclasses_{avg} denotes the average number of subclasses per class, and oSDR_num_set_bits denotes the number of set bits in each oSDR. In the streaming mode, the algorithm can be changed slightly to handle a single oSDR at a time. In this situation, the runtime complexity of the algorithm subroutine is 0(num_subclasses_{avg}×oSDR_num_set_bits) for each oSDR.

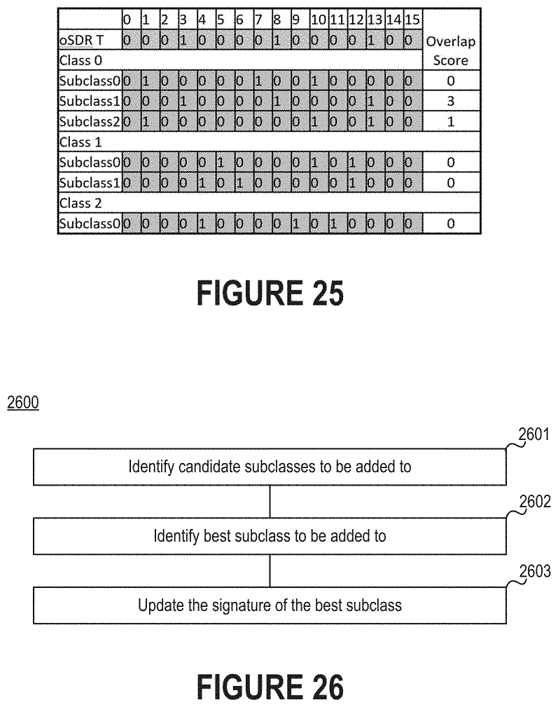

For a testing oSDR, an OLC value can be calculated for each subclass of every class. The subclass with the highest overlap can then be identified. If the OLC value is higher than a minimum threshold—referenced by test_min_overlap—then the parent class of the corresponding subclass is declared as the winner. The minimum threshold could be defined by a user or determined by the system. For example, the testing oSDR T={3,8,13} has the highest overlap score of three with Subclass 1 of Class 0, as shown in FIG. 25. FIG. 25 illustrates the calculated OLC values of a testing oSDR with the signature SDRs corresponding to all subclasses of all classes. If the minimum threshold is set to 66 percent, which translates to a minimum OLC value of 2, then the testing oSDR is predicted to belong to Class 0.

Pseudocode of the algorithm for calculating OLC values of a testing oSDR with respect to the signature SDRs of different subclasses is below. The runtime complexity of the algorithm subroutine is

$$O ( \sum {num}_{{subclasses}_{i}} \times oSDR\_num \_set \_bits ) .$$

As oSDR_num_set_bits tends to be a small number, the complexity of the algorithm subroutine mostly depends on the total number of subclasses. When the number of subclasses becomes substantive (e.g., exceeds several dozen), specialized hardware may be sought to accelerate processing. The algorithm subroutine is parallel, and therefore the runtime can be minimized to

$$O ( ( \frac{\sum {num\_subclasses}_{i}}{p} \times oSDR\_num \_set \_bits ) ,$$

where p is the number of parallel threads that are utilized.

class_f lavor_4(T, num_classes, test_min_overlap)
for i ∈ [0, num_classes) do
Calculate overlapᵢ^{j} = |T ∩ sing_SDRᵢ^{j}| ∀ j ∈ [0, num_subclassesᵢ)
Identify overlapᵢ = max(overlapᵢ^{j}) ∀ j ∈ [0, num_subclassesᵢ
Identify winner such that overlap_{winner} = max(overlapᵢ) ∀ i ∈
[0, num_classes)
return winner

The approach to classification introduced here can satisfy the requirements of sophisticated AI applications. A definition for each subclass of each class in the training data can be maintained as a signature, for example, as defined in the SDR format. Choosing a low sparsity for the signature SDRs guarantees low-shot and noise-resilient learning capabilities as mathematical properties. Moreover, the signature SDRs can be easily explained in terms of combination of ranges of feature values that the subclass definition is sensitive to, using the synaptic map of the neuromorphic model. The classification approach can also support continuous learning with low runtime complexity and memory requirements, as mentioned above. Learning a new class or subclass and its signature SDR can be done instantaneous, incremental, and independent of the definitions learned for existing classes or subclasses. Similarly, if the definition of a subclass drifts—as indicated by drift in the set bits of the oSDRs of samples belonging to the subclass—then the signature SDR can be automatically updated based on the drift. Again, the computation may be incremental and independent of the definitions of other classes or subclasses, allowing for continuous learning in real time.

### Unsupervised Classification for Explainable AI with Continuous Learning

The first two stages of the software pipeline may be entirely unsupervised. In the preceding description of the third stage, the activities of the classifier are supervised. This, in effect, made the entire software pipeline supervised. An unsupervised classification technique, which allows the software pipeline to train with samples in an unsupervised way, can be useful for continuous learning, especially where the model is designed and instructed to learn even when deployed “in the wild.”

For the purposes of classification, training oSDRs can be clustered by class, and a testing oSDR can be classified by identifying the cluster it lies closest to. The classifier can group all of the training oSDRs from a given class into clusters, one for each subclass. For example, in the Modified National Institute of Standards and Technology (MNIST) database of handwritten digits, there are many styles of any given handwritten digit. Each style can potentially be characterized as its own subclass. Further, each subclass definition can be represented with a unique signature SDR that captures the dominant semantics of the members of that subclass.

In the continuous learning mode, the system may not only predict the class of the testing oSDR serving as a sample, but also incrementally train on the same. This approach to training on testing samples can be completed in an unsupervised manner as the testing samples are not labeled. The continuous learning allows the system to track changes in the class and subclass definitions, or the emergence of new classes and subclasses, while deployed in a production environment or an end application. To support this, updates to known subclass definitions and creations of new subclass definitions of unknown classes can respectively be utilized.

The system may initially be trained in a supervised manner, for example, with the supervised_train subroutine described above. After deployment, the system can switch to an unsupervised mode of continuous learning, for example, through the use of the predict_and_train subroutine described below. Unlike the supervised_train subroutine, each testing oSDR can be matched against all of the existing subclasses of the existing classes and the unknown class. The subclass whose signature SDR has the highest overlap with the testing oSDR may be chosen as the prediction if and only if the OLC value is above the entry threshold. In the event that the OLC value exceeds the entry threshold, the corresponding class label p can be returned as the prediction.

Note that the predicted class could alternatively be unknown. In this scenario, the system may prompt the user (e.g., via an interface) and provide the characteristics of the subclass with which the testing oSDR had the highest overlap. This is enabled by the explainable nature of the model. The user may be permitted to provide a label for the subclass after unsupervised learning is complete. Said another way, the system may receive input indicative of a label provided by the user for the subclass. The label could be one of the known labels, in which case the input may be indication of a selection from among the known labels, or the label could be entirely new. Thereafter, the subclass can be moved from the unknown class to the appropriate class based on the user-specified label. Alternatively, if the user does not provide a label, then no further action may be required for the testing oSDR. If OLC value is lower than the entry threshold, then a new subclass of the unknown class can be created and a prediction of “unknown” can be returned. The handling of this prediction may be identical to the explanation set forth above.

```
  Comment: Initializations have been made at the beginning
            of continuous learning mode
  num_subclasses_{unknown} = 0
  sign_SDR_{unknown} = ∅
```

| | |
|---|---|
| predict_and_train(T, | Comment: test sample |
| sign_SDR, | Comment: list of subclass signature SDRs |
| num_classes, | Comment: number of known labeled clases |
| num_subclasses, | Comment: list of number subclasses of each class |
| entry_threshold) | Comment: threshold of overlap to become a member |
| | of known subclass |

```
  Comment: Check if this sample is close to a subclass of any class
  for c ∈ [0, num_classes) do
  Calculate overlapᵢ^{j} = |T ∩ sign_SDRᵢ^{j}| ∀ j ∈ [0, num_subclassesᵢ)
  Identify overlapᵢ = max(overlapᵢ^{j}) ∀j ∈ [0, num_subclassesᵢ)
  Calculate overlap_{unknown}^{j} = |T ∩ sign_SDRᵢ^{j}| ∀ j
              ∈ [0, num_subclasses_{unknown})
  Identify max and p such that overlapₚ^{max} = maximum(overlapₚ^{j})
            ∀ j ∈ [0, num_subclassesₚ) and p ∈ known_classes ∩ {unknown}
Comment: if there is a tie, resolve max such that num_entriesₚ^{max} is minimum
  if overlapₚ^{max} < entry_threshold then
  Comment: Create a new subclass of class unknown
  forall k ∈ T
  strength_{c}^{max}[k] = 1
  push tuple{k,1} to the front of the list sign_SDR_{unknown}^{num}_subclasses^{_{unknown}}
  num_entries_{unknown}^{num}_subclasses^{_{unknown}} = num_entries_{unknown}^{num}_subclasses^{_{unknown}} + 1
  num_subclasses_{unknown} = num_subclasses_{unknown} + 1
  else
  Comment: Add to existing subclass and update signature
  num_entriesₚ^{max} = num_entriesₚ^{max} + 1
  forall k ∈ T′
  strengthₚ^{max}[k] = strengthₚ^{max}[k] + 1
Assign strength parameter of first node in sign_SDRₚ^{max} to min_strengthₚ^{max}
  if strengthₚ^{max}[k] > min_strengthₚ^{max} then
  Pop first node in sign_SDRₚ^{max}
  Insert tuple {k,strengthₚ^{max}[k]} in ascending order to sign_SDRₚ^{max}
  return p, max, sign_SDR
```

### Supervised Classification with Variable Sparsity High-Dimensional Signatures

The supervised classification technique set forth below improves upon the aforementioned classification techniques in several respects, notably where all training oSDRs are clustered based on their class labels and mutual similarity. With this classification technique, the classifier still generates a signature SDR to define a cluster and, like the aforementioned classification techniques, the signature SDR allows the software pipeline to meet the requirements of sophisticated AI applications. Here, however, the signature SDR is richer in semantic information, allowing fewer clusters or signatures per class. Consequently, the runtime of matching a new training oSDR (while training) or a new testing oSDR (while inferencing) against all existing signature SDRs is reduced significantly.

With the aforementioned classification techniques, the classifier can use the same number of set fits in the signature SDRs as in the oSDRs. Because the signature SDRs are very sparse, the amount of information captures in the signatures is limited. With this classification technique, the classifier can address this limitation by using a greater number of set bits in the signature SDR. When a subclass is first created, the signature SDR can have the same number of set bits as the oSDR. Thereafter, the number of set bits can adaptively increase, based on the subsequent members of the subclass, up to a maximum threshold. By increasing the number of set bits in the signature SDR, the chances of having high overlap with subsequent similar oSDRs increases. Consequently, the number of subclasses decreases, which has a significant effect on the runtime complexity of the algorithm executed by the system. With the aforementioned classification techniques, the number of generated signatures is directly proportional to the number of samples included in the training data. Each new sample is matched against all existing signatures, and therefore the runtime was quadratically dependent on the number of samples. With this classification technique, the number of signatures can be reduced by >8× for a given dataset, without any adverse effects to the third-wave properties. This leads to significant decreases in training runtime. In inferencing mode, each sample can be compared against all learned signatures, and an 8× reduction in the number of signatures leads to a commensurate reduction in inferencing runtime.

For succinctness in describing this classification technique, the following notations are used:
oSDRᵢ: {oᵢ¹, oᵢ², oᵢ³, . . . oᵢ^{w}^{ᵢ}} is the i^{th} oSDR input to the classifier.
oᵢ^{j}: Offset of the j^{th} set bit in oSDRᵢ.
wᵢ : Number of set bits in oSDRᵢ, also represented as |oSDRᵢ|. This is a constant in some embodiments for all i, but could vary in other embodients.
sSDRₘ: {Sₘ¹, Sₘ², Sₘ³, . . . Sₘ^{v}^{^{m}}} is the m^{th} signature SDR of a class.
Sₘⁿ: Offset of the n^{th} set bit in sSDRₘ.
l: Length of the oSDRs and sSDRs.
vₘ: Number of set bits in sSDRₘ, also represented as |sSDRₘ|. Note that W≤vₘ≤vₘₐₓ.
vₘₐₓ: Maximum number of set bits allowed in any signature. This value can be derived as the maximum allowable sparsity of any signature SDR.
cᵢ^{m}: Number of common set bits between oSDRᵢ and sSDRₘ.
cₘᵢₙ: Minimum number of common set bits between oSDRᵢ and sSDRₘ, for the former to be assimilated into the latter.
Hₘ: {hₘ¹, hₘ², hₘ³, . . . hₘ^{l}}is a histogram maintained for sSDRₘ in embodiments where signature drift is desired.
Pₘᵢₙ: Minimum number of common set bits between oSDRᵢ and sSDRₘ for the former to be called like the latter during the inferencing stage. Note that Pₘᵢₙ≥Wᵢ.

FIG. 26 includes a flow diagram of a process 2600 for classifying high-dimensional signatures in a supervised manner. Assume that at the beginning of training, there are no known subclasses of any class. At step 2601, the system can identify candidate subclasses to be added to. To accomplish this, oSDRi can be compared with the signatures of all existing subclasses of its class. If there is any subclass, with signature sSDRₘ with which its overlap Cᵢ^{m}≥Cₘᵢₙ, then that subclass can become a candidate to which oSDRᵢ can be added. Said another way, if such a subclass exists, then the system can proceed to step 2602. If no such subclass exists, then the system can proceed to step 2603.

At step 2602, the system can identify the best subclass to add to. To accomplish this, the system can order the subclasses based on overlap with oSDRᵢ. Without loss of generality, assume that the M^{th} subclass with signature sSDRₘ is the subclass with the highest overlap. If two or more subclasses are tired for the highest score, then the tie can be broken by looking at the histograms of those subclasses. First, the overlap between oSDRᵢ and the offsets, of columns with nonzero histogram heights, are calculated and the highest overlap thus obtained is declared the winner. See how oSDR₇ is handled in the example set for below. The generating and updating of the histograms are also further discussed below. If the tie persists, then for each tied subclass, the heights of the overlapping columns can be summed, and the subclass with the highest sum can be declared the winner. See how oSDR₁₀ is handled in the example set for below. If the tie persists, then the tie can be broken arbitrarily.

At step 2603, the system can update the subclass signature. If no subclass was chosen in step 2601, then a new subclass can be created with sSDR=oSDRᵢ. Otherwise, if the subclass with sSDRₘ is identified as the best subclass to which oSDRᵢ should be added, then the system can update the histogram of the subclass by incrementing the height of the columns corresponding to the offsets in the oSDRᵢ by one. Thus, hₘ^{o}^{ᵢ}^{^{j}}=hₘ^{o}^{ᵢ}^{^{j}}+1∀Oᵢ^{j}∈oSDRᵢ. If the number of columns in the histogram with nonzero height in Hₘ is less than or equal to vₘₐₓ, then sSDRₘ={u: hₘ^{u}>0}. Otherwise, the system can identify vₘₐₓ histogram columns with the highest heights and update sSDRₘ as the offsets corresponding to those histogram columns.

For a testing oSDR, an overlap score can be calculated for each subclass of every class. The subclass with the highest OLC value can then be identified. If the OLC value is higher than an overlap threshold, then the parent class of the corresponding subclass is declared the winner. Otherwise, the system may return “unknown classification.”

### Illustrative Example

Assume, for example, that all of the oSDRs are 16 bits long and have 4 set bits. Note that while the number of set bits need not be constant, a constant number has been selected to simplify the explanation. In such a scenario, l=16 and wᵢ=4. For entry into a subclass, an oSDR must have at least 3 common bits (i.e., cₘᵢₙ=3, 75 percent overlap with the set bits in the oSDR). Again, for simplicity, this example concerns subclass generation for samples belonging to the same class. In this example, the maximum allowable number of set bits in a signature SDR is set to 6 (i.e., vₘₐₓ=6).

TABLE I
Iterative explanation in which 11 oSDRs are handled.

| oSDR | Learned Subclasses | Comments |
|---|---|---|
| | ∅ | Initially, no oSDRs are parsed, |
| | | and therefore no subclasses |
| | | exist. |
| oSDR₁ = | sSDR₁ = (0, 1, 2, 3), v₁ = 4 | The first oSDR leads to the |
| {0, 1, 2, 3} | H₁ = {0:1, 1:1, 2:1, 3:1} | creation of the first class. For |
| | | the histogram, only the heights |
| | | of the histograms that are non- |
| | | zero are shown. The column |
| | | identifier is shown first |
| | | followed by a colon, followed by |
| | | the height of the histogram. |
| oSDR₂ = | sSDR₁ = {0, 1, 2, 3, 4}, v₁ = 5 | The overlap score of oSDR₂ with |
| {1, 2, 3, 4} | H₁ = {0:1, 1:2, 2:2, 3:2, 4:1} | sSDR₁, i.e., c₂¹ = 3 is equal to |
| | | cₘᵢₙ = 3. Therefore, the |
| | | histogram is updated. As the |
| | | number of columns with |
| | | histograms with non-zero |
| | | height = 5 ≤ vₘₐₓ = 6, the signa- |
| | | ture is updated to have all these |
| | | columns. |
| oSDR₃ = | sSDR₁ = {0, 1, 2, 3, 4, 5}, v₁ = 6 | The overlap score of oSDR₃ with |
| {2, 3, 4, 5} | H₁ = {0:1, 1:2, 2:3, 3:3, 4:2, 5:1} | sSDR₁, i.e., c₃¹ = 3 is equal to |
| | | cₘᵢₙ = 3. Therefore, the |
| | | histogram is updated. As the |
| | | number of columns with |
| | | histograms with non-zero |
| | | height = 6 ≤ vₘₐₓ = 6, the sig- |
| | | nature is updated to have all |
| | | these columns. |
| oSDR₄ = | sSDR₁ = {0, 1, 2, 3, 4, 5}, v₁ = 6 | The overlap score of oSDR₄ with |
| {3, 4, 5, 6} | H₁ = {0:1, 1:2, 2:3, 3:4, 4:3, 5:2, | sSDR₁, i.e., c₄¹ = 3 is equal to |
| | 6:1} | cₘᵢₙ = 3. Therefore, the |
| | | histogram is updated. However, |
| | | the number of histograms with |
| | | nonzero values is 7 > vₘₐₓ = 6./ |
| | | therefore, a selection of the top |
| | | 6 columns with the highest |
| | | histograms is made. There is |
| | | tie for the 6^{th} position for |
| | | columns 0 and 6, with both |
| | | having histograms with a height |
| | | of 1. The tie is broken with a |
| | | propensity to retain the previous |
| | | signature. As column 0 appears |
| | | in the previous signature, it is |
| | | retained in the updated |
| | | signature. |
| oSDR₅ = | sSDR₁ = {1, 2, 3, 4, 5, 6}, v₁ = 6 | The overlap score of oSDR₅ with |
| {4, 5, 6, 7} | H₁ = {0:1, 1:2, 2:3, 3:4, 4:4, 5:3, | sSDR₁, i.e., c₅¹ = 3 is equal to |
| | 6:2, 7:1} | cₘᵢₙ = 3. Therefore, the |
| | | histogram is updated. However, |
| | | the number of histograms with |
| | | nonzero is now 8 > vₘₐₓ = 6, |
| | | therefore, a selection of the top |
| | | 6 columns with the highest |
| | | histograms are chosen for the |
| | | signature. Signature shift is |
| | | becoming evident at this |
| | | point. |
| oSDR₆ = | sSDR₁ = {1, 2, 3, 4, 5, 6}, v₁ = 6 | The overlap score of oSDR₆ with |
| {0, 1, 2, 7} | H₁ = {0:1, 1:2, 2:3, 3:4, 4:4, 5:3, | sSDR₁, i.e., c₆¹ = 2 < cₘᵢₙ = 3. |
| | 6:2, 7:1} | Therefore, a new subclass is |
| | sSDR₂ = {0, 1, 2, 7}, v₁ = 4 | created with signature sSDR₂ |
| | H₂ = {0:1, 1:1, 2:1, 7:1} | and histogram H₂. |
| oSDR₇ = | sSDR₁ = {1, 2, 3, 4, 5, 6}, v₁ = 6 | The overlap score of oSDR₇ with |
| {1, 2, 3, 7} | H₁ = {0:1, 1:3, 2:4, 3:5, 4:4, 5:3, | sSDR₁ and sSDR₂: c₇¹, c₇² = 3 |
| | 6:2, 7:2} | which is ≥ cₘᵢₙ = 3. Therefore, |
| | sSDR₂ = {0, 1, 2, 7}, v₁ = 4 | both subclasses are candidates |
| | H₂ = {0:1, 1:1, 2:1, 7:1} | and tied for overlap score. The |
| | | ties can be broken by looking at |
| | | the histograms H₁ and H₂, and |
| | | counting the overlap with the |
| | | columns with nonzero |
| | | histogram-heights. For |
| | | example, oSDR₇ overlaps with |
| | | 4 columns in H₁ (i.e., 1, 2, 3, 7) |
| | | but only 3 columns in H₂ (i.e., |
| | | 2, 3, 7). Therefore, oSDR₇ is |
| | | added to Subclass1. |
| oSDR₈ = | sSDR₁ = {1, 2, 3, 4, 5, 6}, v₁ = 6 | The overlap score of oSDR₈ |
| {0, 2, 3, 7} | H₁ = {0:1, 1:3, 2:4, 3:5, 4:4, 5:3, | with only sSDR₂ is ≥ cₘᵢₙ = 3. |
| | 6:2, 7:2} | As the number of columns with |
| | sSDR₂ = {0, 1, 2, 3, 7}, v₁ = 5 | histograms with non-zero |
| | H₂ = {0:2, 1:1, 2:2, 3:1, 7:2} | height = 5 ≤ vₘₐₓ = 6, the oSDR is |
| | | added to the subclass and its |
| | | histogram (sSDR₂) and the |
| | | signature (H₂) are updated. |
| oSDR₉ = | sSDR₁ = {1, 2, 3, 4, 5, 6}, v₁ = 6 | Only the overlap score of oSDR₉ |
| {0, 1, 7, 8} | H₁ = {0:1, 1:3, 2:4, 3:5, 4:4, 5:3, | with sSDR₂ is ≥ cₘᵢₙ = 3. As |
| | 6:2, 7:2} | the number of columns with |
| | sSDR₂ = {0, 1, 2, 3, 7, 8}, v₁ = 6 | histograms with non-zero |
| | H₂ = {0:3, 1:2, 2:2, 3:1, 7:3, 8:1} | height = 6 ≤ vₘₐₓ = 6, the oSDR is |
| | | added to the subclass and its |
| | | histogram (sSDR₂) and the |
| | | signature (H₂) are updated. |
| oSDR₁₀ = | sSDR₁ = {1, 2, 3, 4, 5, 6}, v₁ = 6 | Only the overlap score of |
| {0, 4, 7, 8} | H₁ = {0:1, 1:3, 2:4, 3:5, 4:4, 5:3, | oSDR₁₀ with sSDR₂ is = 3 ≥ |
| | 6:2, 7:2} | cₘᵢₙ = 3. However, the number |
| | sSDR₂ = {0, 1, 2, 3, 7, 8}, v₁ = 6 | of histograms with nonzero is |
| | H₂ = {0:4, 1:2, 2:2, 3:1, 4:1, 7:4, | 7 > vₘₐₓ = 6; therefore, a |
| | 8:2} | selection of the top 6 columns |
| | | with the highest histograms is |
| | | made. There is tie for the 6^{th} |
| | | position for columns 3 and 4, |
| | | with both having histograms |
| | | with a height of 1. The tie is |
| | | broken with a propensity to |
| | | retain the previous signature. |
| | | As column 3 appears in the |
| | | previous, it is retained in the |
| | | updated signature. |
| oSDR₁₁ = | sSDR₁ = {1, 2, 3, 4, 5, 6}, v₁ = 6 | The overlap score of oSDR₁₁ |
| {0, 1, 2, 4} | H₁ = {0:1, 1:3, 2:4, 3:5, 4:4, 5:3, | with sSDR₁ and sSDR₂ : c₇¹, c₇² = |
| | 6:2, 7:2} | 3 which is ≥ cₘᵢₙ = 3. |
| | sSDR₂ = {0, 1, 2, 3, 7, 8}, v₁ = 6 | Therefore, both subclasses are |
| | H₂ = {0:4, 1:2, 2:2, 3:1, 4:1, 7:4, | candidates and tied for overlap |
| | 8:2} | score. Like in the case of |
| | | oSDR₇, the histograms H₁ and |
| | | H₂ are investigated first. |
| | | Counting the overlap with the |
| | | columns with nonzero |
| | | histogram-heights doesn’t |
| | | resolve the tie, since oSDR₁₁ |
| | | overlaps with 4 columns in both |
| | | H₁ and H₂, at columns |
| | | 0, 1, 2 and 4. Next, the heights of |
| | | the histogram of overlapping |
| | | columns are added, The sum of |
| | | heights of histograms for |
| | | columns 0, 1, 2 and 4 is 12 for |
| | | subclass 1, and 9 for subclass |
| | | 2. Therefore, oSDR₁₁ is added |
| | | to the first subclass. |
| | | If the subclasses were still tied, |
| | | then the tie would have been |
| | | broken arbitrarily. |

This classification technique maintains a definition for each subclass of every class, in the training data, as its signatures are defined in the SDR format. Choosing a low maximum sparsity for the signature SDRs guarantees low-shot and noise-resilient capabilities as mathematical properties. These signature SDRs can be easily explained, in terms of combination of ranges of feature values, to which the subclass definitions are sensitive, using the synaptic map of the neuromorphic model. This classification technique can also support continuous learning with low runtime complexity and memory requirements as mentioned above. Learning a new class or subclass and its signature SDR can be done immediately, incrementally, and independently of the definitions of existing classes or subclasses. This may happen if during the inferencing stage, a testing oSDR does not sufficiently overlap any of the known signature SDRs. In such a scenario, a new subclass of the unknown type can be created with the oSDR set as its signature SDR. Similarly, if the definition of a class or subclass drifts, then the signature SDR can be automatically updated to account for the drift. Again, the computation may be incremental and independent of the definition of other classes or subclasses, allowing for continuous learning in real time.

### Explainability

One of the key advantages of the system introduced here is the ability to explain results that are achieved. Simply put, the system can explain what was learned during training and why learning occurred. Similarly, the system can explain why a particular result was obtained.

As discussed above, the system-embodied as a software pipeline-has three processing elements, each of which is responsible for a different stage of processing. At a high level, an encoder may be responsible for creating input SDRs (iSDRs) from the raw data obtained as input, a processing unit (e.g., NPU) may be responsible for processing the iSDRs to learn patterns in the raw data, and a classifier may be responsible for taking output SDRs (oSDRs) produced by the processing unit and then creating signatures of the patterns found by the processing unit.

Each stage of the software pipeline is human understandable in the forward and backward directions, making the software pipeline “explainable” in terms of answering two important questions in ML, namely, why did the machine learn from training data and why did the model classify an input represented with testing data in a certain way.

### A. Encoder Explainability

At a high level, the encoder is representative of a transform function that transforms raw data into a bit vector in SDR format. Parameters—which may be user specified—for the encoder can be stored in the model state file, so that a user can understand, at any point in time, the parameters used in the transform and therefore can reverse the transform. The encoder may be configured to take continuous data (e.g., integers or floating point numbers) or discrete data (e.g., string variable or categorical variable). Regardless of data type, the encoder can convert raw data provided as input to a discrete spatial representation that is largely or entirely void of endian order by placing binary set bits (i.e., “ones”) in discrete “buckets.” The number of binary set bits in a bucket may be at least one, and there will typically be some amount of set-bit overlap between adjacent buckets. The overlap exists to reinforce semantic similarity (e.g., the number 1.2 is more semantically similar to the numbers 1.1 and 1.3 than to the number 5.9, and therefore the number 1.2 will be encoded into a bucket that has positional set-bit overlap with the buckets for the numbers 1.1 and 1.3). The discretization of data may create a small amount of uncertainty when reversing the transform applied by the encoder.

### B. Neural Processing Unit (NPU) Explainability

As discussed above, the NPU can learn spatial patterns in data through Hebbian-like learning using the biological concepts of neurons and synapses. Importantly, neurons whose synapses are best connected to the positions of the set bits of the input SDR (iSDR) can be selected to represent the pattern found in the iSDR and incorporated into an output SDR (oSDR) that is supplied to the classifier. The synaptic connections for each neuron can be stored in the model state file, making it possible to understand which bits were set in the iSDR for a given neuron. Because the identity of the neurons is known in the oSDR, it is possible to determine the iSDR set-bit positions from a group of neurons in the oSDR. However, there may be some uncertainty in the translation of the oSDR to the iSDR because not all “connected” synapses of a given neuron in the oSDR may have been connected to a set bit in the iSDR. The purpose of learning in the NPU is to tune the synaptic connections in response to the patterns of set bits seen in the iSDRs, and thus the synaptic connections of a trained model should be a very close, though not necessarily perfect, match to the bit patterns seen in the iSDR.

### C. Classifier Explainability

The classifier can learn classification signatures from the oSDRs produced by the NPU. Each oSDR can be evaluated for one of two actions: whether to use the oSDR to create a new signature or include the oSDR in an existing signature. A threshold of hamming distance may be used to determine which of these actions should be taken. In the scenario where no signature exists (i.e., the first oSDR), then a new signature can be automatically created from that oSDR. When an oSDR is included with an existing signature, is may or may not alter the existing signature to some degree. In training mode, a classification label (e.g., provided in the raw data) can be presented to the classifier along with the oSDRs when training is supervised. When training is unsupervised, the oSDRs can be presented to the classifier without any labels. Finally, each class of data object (e.g., according to its label when supervised, or according to its clustering when unsupervised) can have more than one signature definition. For example, a given class may be associated with multiple signatures, each of which is representative of, and corresponds to, a different subclass of the given class.

In the present disclosure, it is explained how to use class signatures and subclass signatures to explain what the model has learned from the raw data, as well as to explain why the model made a particular classification for a given input. The former deals with training and understanding the trained model, while the latter deals with inferencing and understanding how a data observation aligns with the trained model.

To understand what the model has learned during training, class signatures and/or subclass signatures can be processed to find the original raw data ranged by using the known model parameters along with certain user parameters associated with explainability. Examples of model parameters include (i) neuron identifiers contained in the signature, as obtained from the classifier; (ii) synaptic connections for each signature, as obtained from the NPU; and (iii) set bits, sparsity, and window span used for encoding, as obtained from the encoder. Examples of user parameters include (i) the synapse threshold that defines a threshold percentage for synapses that are common between neurons and (ii) the bucket threshold that defines a threshold percentage for buckets that are common between connected synapses.

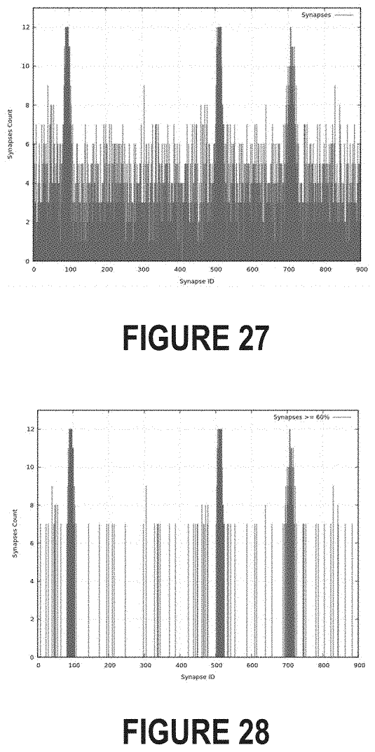

The explanation process may begin with a class signature or subclass signature from which a list of neuron identifiers can be collected. The neuron identifiers from the signature correspond to neurons in the NPU, where the synapses for each of the neurons can be identified and mapped onto a histogram as synapse number as shown in FIG. 27. In the example shown in FIG. 27, there are 900 total bits in the iSDR, and one or more unique synapses map to each of the bit positions. When the synapses from all of the neurons in the signature generated by the classifier are mapped onto the histogram, it can be observed that some synapses appear more frequently than others. The first threshold to be applied is the synapse threshold to filter out synapses that appear less frequently. In FIG. 28, the synapse threshold is set at 60 percent of the maximum synaptic connection count (i.e., 12×0.6=7.2, which may be rounded to the nearest integer value of 7).

By applying the synapse threshold and determining a surviving set of synaptic connections, the pattern of synaptic connections can be learned by the NPU. Thereafter, attention may be turned to the encoder and converting the synaptic connections to encoded bucket boundaries and then to raw data.

The remaining synapses can be processed using the settings of the encoder to get back to the raw data. To accomplish this, the encoder parameters can initially be used to recreate the bucket boundaries for each feature in the raw data. The term “bucket,” as used here, refers to the smallest discrete unit of encoding in the iSDR, though it often represents a range of continuous numbers from raw data.

TABLE II
Example of raw data, and specifically ranges of
values, mapped to different bucket identifiers.

| Raw Data Values | Encoder Bucket ID |
|---|---|
| 1.0-1.19 | B_{ID} = 1 |
| 1.2-1.39 | B_{ID} = 2 |
| 1.4-1.59 | B_{ID} = 3 |

The encoder bucket boundaries can be understood from the encoder model parameters of field width (i.e., the number of bit positions in an encoded field) and the number of binary set bits used during encoding. For a linear encoder, the number of buckets can be given as:

Number of Buckets=Field Width−Set Bits+1.

If, for example, the field width equals 300 bits and the number of set bits is 15, then the bucket width equals 15, the number of buckets equals 286 (i.e., 300−15+1), and the bucket overlap is 14 bit positions (i.e., 15−1).

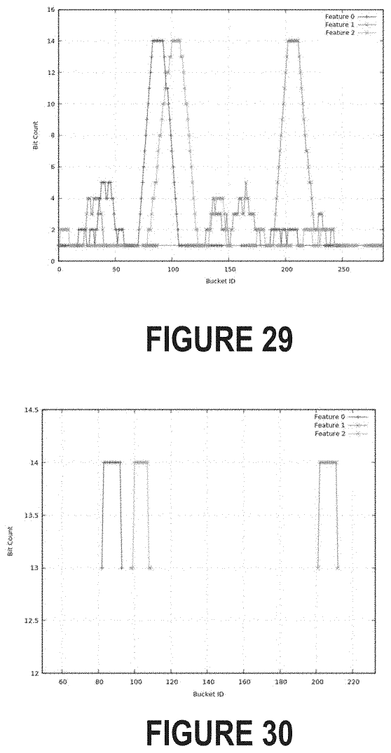

With the bucket count and width identified, a graph can be constructed (e.g., by the NPU or host processing unit) that maps the number of synaptic connections for each bucket. The first bucket would sum the number of synapses connected in bit positions 1-5, the second bucket would sum the number of connections in bit positions 2-16, and so on until the last bucket summed the connections in bit positions 386-300. FIG. 29 includes an example of a graph illustrating the mapping of synaptic connections to encoder buckets. The 900 synaptic positions from FIG. 28 are grouped by features (e.g., based on the field width), 300 positions each, and then counted based on which bucket each falls into. In this example, the maximum number of synapses in the buckets is 14. Although this example has uniform distribution, it is possible for bimodal or other distributions to appear in the graph of synaptic connections mapped to encoder buckets. In such a scenario, other user parameters can be used to merge buckets until a desired result is achieved.

With the synapse-to-bucket mapped completed, a final filter can be applied to remove unwanted or noninformative peaks from the results. This user parameters is called the bucket threshold, and it can be set at any level that yields the desired results. Continuing with the same example and setting the bucket threshold at 13, the system can obtain FIG. 30. Specifically, FIG. 30 illustrates the synapse-to-encoder buckets after filtering with a bucket threshold defined by a user.

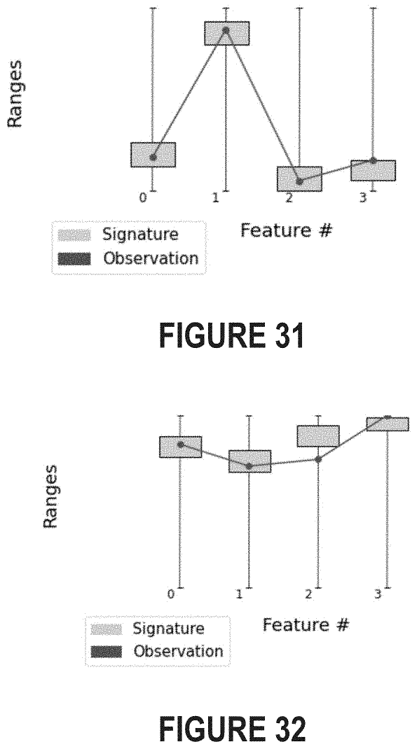

With the final list of encoder buckets, the system can now transform the buckets into raw data ranges. Using the stored encoder settings and minimum/maximum range values for each feature, the system can complete the process of explaining a learned signature in terms of the raw data that created it. In FIG. 31, ranges of raw data for a four-feature dataset are shown in bar-chart format. The bars represent one of the data patterns learned by the NPU and a signature created by the classifier. The bar chart “explains” in a human-understandable way what the model has learned from the raw data provided for training purposes, and any data that falls within the displayed ranges should result in the same classification. Many visualization components like FIG. 31 could exist for a single set of training data, for example, with one explanation for each class or subclass discovered and defined by the NPU and classifier.

In addition to understanding what the model learned from the data, a user can also use the system to understand why a new observation has been classified by the model in a certain way. In FIG. 31, the line represents a new observation that was presented to the model. Based on the high overlap with the bars, it is highly probable that the model will classify this observation with the same signature used to create the bar chart. In FIG. 32, however, the new data observation misses two of the bars, and therefore may not be classified with the same signature used to create the bar chart. In this scenario, there may be another signature that is a better match.

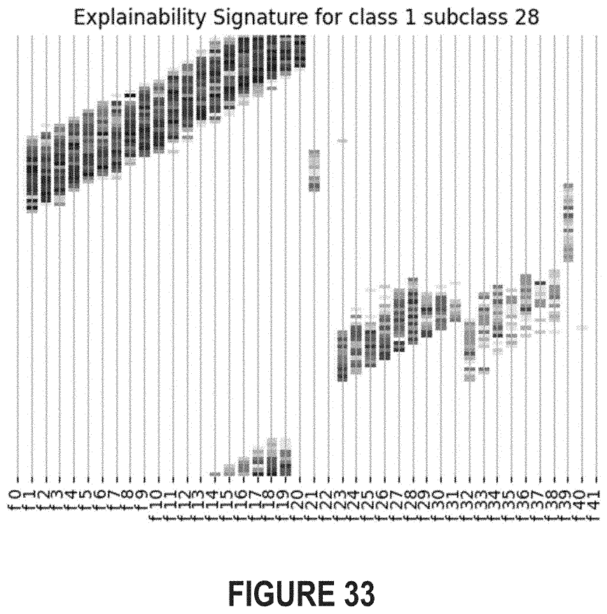

Another method for displaying the results is to use a heat map for synaptic connections as shown in FIG. 33. With this type of visualization component, a user can see qualitatively how many synapses were connected for each bucket in the value range.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A method performed by a computational system comprising (i) an encoder, (ii) a neural processing unit, and (iii) a classifier, the method comprising;
receiving, by the encoder, data as input and producing, based on the data, a first Sparse Distributed Representation (SDR) as output;
receiving, by the neural processing unit, the first SDR as input and producing, based on the first SDR, a second Sparse Distributed Representation (SDR) as output; and
receiving, by the classifier, the second SDR as input and producing, based on the second SDR, a signature for a class of which the data is a part.

2. The method of claim 1, wherein the classifier further receives a label that is indicative of the class.

3. The method of claim 2, further comprising:
associating, by the classifier, the signature with the label in a data structure, such that the signature is representative of the class.

4. The method of claim 2, wherein the label is included in the data received by the encoder.

5. The method of claim 1, wherein to produce the first SDR, the encoder converts the data from a vector representation to a sparse hyperdimensional format.

6. The method of claim 1, wherein the first and second SDRs are representative of unordered collections of set bits.

7. The method of claim 1, further comprising:
comparing, by the classifier, the signature against multiple signatures, each of which is representative of a different class or subclass;
determining, by the classifier, that the signature matches one of the multiple signatures; and
outputting, by the classifier, a prediction for the data based on the matching signature.

8. The method of claim 7, wherein each of the multiple signatures is indicative of a reference Sparse Distributed Representation (SDR) that is determined to be representative of the corresponding class or subclass.

9. The method of claim 7,
wherein said comparing causes a value to be produced for each of the multiple signatures that is representative of amount of overlap with the signature, and
wherein said determining comprises establishing the matching signature has a highest amount of overlap as indicated by a highest value.

10. A computational system comprising:
an encoder configured to receive data as input and produce, based on the data, a first series of Sparse Distributed Representations (SDRs) as output;
a neural processing unit configured to receive the first series of SDRs as input and produce, based on the first series of SDRs, a second series of Sparse Distributed Representations (SDRs) as output; and
a classifier configured to receive the second series of SDRs as input and produce, based on the second series of SDRs, a series of signatures,
wherein each signature in the series of signatures is associated with (i) a first SDR in the first series of SDRs, (ii) a second SDR in the second series of SDRs, and (iii) a portion of the data, and
wherein each signature conveys information regarding a corresponding object, represented by the portion of the data, based on locations of nonzero bits in the second SDR.

11. The computational system of claim 10, wherein the data received by the encoder is in the form of a vector with an ordered set of values for the features.

12. The computational system of claim 10, wherein the neural processing unit is a subcomponent of a natural neural processor that has a reconfigurable Multiple Instruction Single Data (MISD) architecture.

13. The computational system of claim 10, wherein the encoder is able to mimic a linear encoder or a random distributed encoder based on a setting programmed in the computational system.

14. The computational system of claim 10,
wherein the encoder represents each SDR in the first series of SDRs as an ordered index, indicating set bits in that SDR, and
wherein the neural processing unit represents each SDR in the second series of SDRs as an ordered index, indicating set bits in that SDR.

15. The computational system of claim 10, wherein each SDR in the second series of SDRs is representative of a data structure in which bit are set to independently convey semantic meaning.

16. The computational system of claim 15, wherein overlap between a pair of SDRs in the second series of SDRs is indicative of similarity between the pair of SDRs.

17. A non-transitory medium with instructions stored thereon that, when executed by a processing unit of a computational system, cause the computational system to perform operations comprising:
receiving data as input and producing, based on the data, a first Sparse Distributed Representation (SDR) as output;
producing a second Sparse Distributed Representation (SDR) based on the first SDR; and
producing a signature for a class of which the data is a part based on the second SDR.

18. The non-transitory medium of claim 17, wherein the data is accompanied by a label that is indicative of the class, and wherein the operations further comprise:
associating the signature with the label in a data structure, such that the signature is representative of the class.

19. The non-transitory medium of claim 17, wherein the operations further comprise:
comparing the signature against multiple signatures, each of which is representative of a different class or subclass;
determining that the signature matches one of the multiple signatures; and
outputting a prediction for the data based on the matching signature.

20. The non-transitory medium of claim 19, wherein each of the multiple signatures is indicative of a reference Sparse Distributed Representation (SDR) that is determined to be representative of the corresponding class or subclass.
